(19) United States
(12) Patent Application Publication
(10) Pub. No.: US 2025/0253106 A1
(43) Pub. Date: Aug. 7, 2025

(54) Push Button Switch

(71) Applicant: IDEC CORPORATION, Osaka-shi, Osaka (JP)

(72) Inventors: Masashi FUJIMOTO; Takashi IWAMI, Osaka-shi, Osaka (JP); Shigetoshi FUJITANI, Osaka-shi, Osaka (JP); Takayuki SAKAI, Osaka-shi, Osaka (JP); Atsushi MATSUMOTO, Osaka-shi, Osaka (JP); Yuki KAWASE, Osaka-shi, Osaka (JP)

(21) Appl. No.: 18/856,310

(22) PCT Filed: Mar. 20, 2023
(86) PCT No.: PCT/JP2023/010871

§ 371 Date: Oct. 11, 2024

(30) Foreign Application Priority Data
Apr. 11, 2022 (JP) 2022-065439
Jan. 31, 2023 (JP) 2023-012582

(51) Int. Cl. H01H 13/62; H01H 13/14

(52) U.S. Cl. CPC H01H 13/62; H01H 13/14

(57) ABSTRACT

The present invention provides a push button switch that prevents an occurrence of non-matching of contacts. The push button switch 1 includes a push-operatable and return-operatable push button 20, the first and second pairs of contacts C₁, C₂ that are respectively transferred to an open state by a push-in operation of the push button 20 and transferred to a contact state by a return operation of the push button 20, and a return-speed increasing means that applies and releases a load relative to the push button 20 during the return operation of the push button 20 and that functions to increase a return speed in the return-operation direction of the push button 20. The inclined angles R of the second inclined surfaces 24₁a, 24₂a of the respective engagement members 24₁, 24₂ is determined such that the second inclined surfaces 24₁a, 24₂a function as the return-speed increasing means.

### TECHNICAL FIELD

The present invention relates generally to a push button switch and more particularly to an improvement of the structure for preventing an occurrence of non-matching of contacts.

### BACKGROUND ART

Japanese patent publication No. 3899281 discloses a push button switch. As shown in FIGS. 1 and 2 of the publication, the push button switch (1) includes a push button (5), a button housing portion (9) that supports the push button (5) in a push-operable manner, and a contact housing portion (7) that has a plurality of pairs of contacts composed of a first contact (17) and a second contact (19) that is contactable and separable relative to the first contact (17). The button housing portion (9) and the contact housing portion (7) constitute a switch case (3). Inside the button housing portion (9), there is provided a cylindrical body (45) that travels along with the push button (5).

At a lower end portion of the cylindrical body (45), a protrusion (57) that protrudes radially outwardly is provided. Inclined surfaces (61, 59) are formed at an upper and lower surface of the protrusion (57) respectively. On the other hand, at a position near a lower end portion of the button housing portion (9), there is provided a movable member (37) that is movable in a direction perpendicular to an axial direction of the cylindrical body (45). The movable member (37) is biased toward the cylindrical body (45) by an action of an elastic repulsion of a spring (39). At an upper and lower surface of the movable member (37), inclined surfaces (43, 41) are formed that are respectively engageable with the inclined surfaces (61, 59) of the protrusion (57). Also, inside the contact housing portion (7), there is provided a spring (31) as opening biasing means that biases the first and second contacts (17, 19) in an opening/separating direction.

Prior to a push-operation of the push button (5), an upper-side inclined surface (41) of the movable member (37) is engaged with a lower-side inclined surface (59) of the protrusion (57) of the cylindrical body (45) (see FIG. 1 of the publication). Also, at this moment, the second contact (19) is in contact with the first contact (17) and the contact is ON. From this state, when an operator presses down the push button (5), as the cylindrical body (45) traveling along with the push button (5) tries to move downwardly, the lower-side inclined surface (59) of the protrusion (57) presses down the upper-side inclined surface (41) of the movable member (37), such that thereby the movable member (37) gradually moves backward against the elastic repulsion of the spring (39), sliding in contact with the protrusion (57). Then, when the inclined surface (59) of the protrusion (57) climbs over the inclined surface (41) of the movable member (37), the cylindrical body (45) moves downwardly to cause the push button (5) to move downwardly, the second contact (19) moves away from the first contact (17), and the contact turns OFF. Subsequent to the press-down operation of the push button (5), the lower-side inclined surface (43) of the movable member (37) is in engagement with the upper-side inclined surface (61) of the protrusion (57) of the cylindrical body (45) (see FIG. 2 of the publication).

Next, from the press-down state of the push button (5) (see FIG. 2 of the publication), in order to return-operates the push button (5) back to the position prior to the press-down operation, the operator pulls up the push button (5). Then, as the cylindrical body (45) traveling along with the push button (5) tries to move upwardly, the upper-side inclined surface (61) of the protrusion (57) presses the lower-side inclined surface (43) of the movable member (37) upwardly, such that thereby the movable member (37) gradually moves backward against the elastic repulsion of the spring (39), sliding in contact with the protrusion (57). Then, when the inclined surface (61) of the protrusion (57) climbs over the inclined surface (43) of the movable member (37), the cylindrical body (45) moves upwardly to cause the push button (5) to move upwardly, the second contact (19) comes into contact with the first contact (17) and the contact turns ON. Subsequent to the return-operation of the push button (5), the upper-side inclined surface (41) of the movable member (37) is in engagement with the lower-side inclined surface (59) of the protrusion (57) of the cylindrical body (45) (see FIG. 1 of the publication).

### PRIOR ART REFERENCES

### Patent Documents

Patent Document 1: Japanese patent publication No. 3899281 (see FIGS. 1 and 2).

### SUMMARY OF THE INVENTION

### Objects to be Achieved by the Invention

In the above-mentioned push button switch (1), when returning the contact to an ON-state by the return operation of the push button (5), the state of non-matching of contacts sometimes occurs in which either pair of contacts in a plurality of pairs of contacts turns ON first and at that moment another pair of contacts remains an OFF-state (that is, after some pairs of contacts turn ON, other pairs of contacts subsequently turns ON, and thus a time lag of ON-timing arises). Such a non-matching of contacts is determined as an error by a machine-system side on safety grounds and a machine cannot resume operations. Therefore, a need exists to find an effective measures for the non-matching of contacts.

Also, as the above push button switch (1), in the case that the spring (31) as an opening biasing means is provided, since the second contact (19) is always biased downwardly in the figure by the spring force of the spring (31), the cylindrical body (45) is always biased downwardly in the figure as well. Therefore, during the push operation of the push button (5), the spring force of the spring (31) acts to assist the push operation of the push button (5), whereas during the return operation of the push button (5), the operator has to return-operate the push button (5) against the spring force of the spring (31) and as a result of this, a non-matching of contacts is likely to occur during the return operation.

The present invention has been made in view of these circumstances and its object is to provide a push button switch that can prevent a non-matching of contacts.

### Means of Achieving the Objects

A push button switch according to the present invention includes a push-operatable and return-operatable push button, a first pair of contacts and a second pair of contacts that are respectively put in an open state by a push operation of the push button and put in a contact state by a return operation of the push button, and a return-speed increasing means that applies and releases a load relative to the push button during the return operation of the push button and that functions to increase a return speed in a return-operational direction of the push button.

According to the present invention, during the return operation of the push button, by the action of the return-speed increasing means, a load is applied to the push button, the load is then released, and the return speed in the return-operational direction of the push button is thus increased. Thereby, during the return operation, when the first and second pairs of contacts respectively move to a contact state, a time lag between the both contacts can be prevented from occurring, thus preventing a non-matching of contacts from arising.

In the present invention, the return-speed increasing means may include a first engagement portion that is provided on the side of the push button and that moves along with the push button and a second engagement portion that is provided on the side of a case for holding the push button and that the first engagement portion is releasably engageable with. An engagement surface of at least either one of the first and second engagement parts may be determined in such a way that a load acting from the first engagement portion to the second engagement portion during the return operation of the push button gradually becomes greater, and when the load is resolved in the return-operational direction and an orthogonal direction relative to the return-operational direction, a return-operational component force in the return-operational direction is greater than an orthogonal component force orthogonal to the return-operational component force.

According to the present invention, during the return operation of the push button, the return-operational component force acting in the return-operational direction of the push button is increased and the increased return-operational component force is applied to the push button in the return-operational direction. Thereby, when the load is released by the return-speed increasing means, the push button can move quickly at a large acceleration in the return operational direction. As a result, a non-matching of the first and second pairs of contacts can be surely prevented from occurring during the return operation.

In the present invention, the return-speed increasing means may include at least two first engagement portions that are provided on the side of the push button and that move along with the push button and at least two second engagement portions that are provided on the side of a case for holding the push button and that the first engagement portions are respectively releasably engageable with during the return operation of the push button.

According to the present invention, during the return operation of the push button, since at least two first engagement portions moving along with the push button respectively come into engagement with at least two second engagement portions on the case side, the return-operational component force acting in the return operational direction of the push button is increased and the increased return-operational component force is applied to the push button in the return operation direction. Thereby, when the load by the return-speed increasing means is released, the push button can move rapidly with a large acceleration in the return operational direction. Accordingly, the first and second pairs of contacts can be surely prevented from causing a non-matching of contacts during the return operation.

In the present invention, the return-speed increasing means may include a first engagement portion that is provided on the side of the push button and that moves along with the push button, a second engagement portion that is provided on the side of a case for holding the push button and that the first engagement part is releasably engageable with, and a biasing means that biases the push button in the return-operational direction.

According to the present invention, during the return operation of the push button, the biasing force by the biasing means is imparted in the return operational direction of the push button and the force to the push button in the return operational direction is increased. Thereby, when the load by the return-speed increasing means is released, the push button can move quickly with a large acceleration in the return operational direction. As a result, the first and second pairs of contacts can be surely prevented from causing a non-matching of contacts during the return operation.

In the present invention, the return-speed increasing means may include a first engagement portion that is provided on the side of the push button and that moves along with the push button, a second engagement portion that is provided on the side of a case for holding the push button and that the first engagement portion is releasably engageable with, a chamber that is provided on the side of the case, and a partition member that is adapted to move along with the push button, that partitions the chamber into two compartments, and that allows for air to move from a compartment in which an internal pressure is increased to another compartment during the return operation of the push button.

According to the present invention, during the return operation of the push button, as the partition member moves inside the chamber, the internal pressure of one compartment of the chamber is increased and thus a load to the push button is increased. Also, during the return operation, by the action of the partition member, as air is moved from one compart of the chamber to another compartment, one compartment is depressurized and the load to the push button is increased. Thereby, the push button can move rapidly with a large acceleration in the return operational direction. Consequently, the first and second pairs of contacts can be surely prevented from causing a non-matching of contacts during the return operation.

In the present invention, the first engagement portion may be composed of a protruding portion formed of a pair of inclined surfaces that are spaced away along an axial direction of a shaft portion of the push button. The second engagement part may be composed of an engagement member that includes a first inclined surface and a second inclined surface engageable with the respective inclined surfaces of the protruding portion and that is provided movably toward and away from the protruding portion of the push button. A biasing means may be provided that biases the engagement member toward the protruding portion of the push button.

In the present invention, one of the inclined surfaces of the protruding portion of the push button is adapted to come into contact with the first inclined surface of the engagement member during the push operation, and the other of the inclined surfaces of the protruding portion of the push button is adapted to come into contact with the second inclined surface of the engagement member during the return operation.

In the present invention, the first pair of contacts may be disposed on one side of the shaft portion of the push button, and the second pair of contacts may be disposed on another side of the shaft portion of the push button.

The present invention may further comprise an opening-biasing means that respectively biases the first and second pairs of contacts in the opening direction.

In the present invention, the opening-biasing means is adapted to assist the push operation of an operator during the push operation of the push button and to resist the return operation of the operator during the return operation of the push button.

In the present invention, the push button switch may be an emergency stop switch.

### Effects of the Invention

As mentioned above, according to the present invention, since during the return operation of the push button, the return-speed increasing means applies a load to the push button and releases the load and the return speed in the return operational direction of the push button is thus increased, the first and second pairs of contacts can be prevented from causing a time lag between both of the contacts when they respectively move to the contact state during the return operation, thereby preventing a non-matching of contacts from occurring.

### BRIEF DESCRIPTION OF THE DRAWINGS

FIG. 1 is a general perspective view of a push button switch according to a first embodiment of the present invention;

FIG. 2 is a general perspective view with a cutaway of the push button switch of FIG. 1;

FIG. 3 is a front elevational view which shows the internal structure of the push button switch of FIG. 2, in which the push button, the holding case for the push button, and the contact housing in FIG. 2 are removed, illustrating the state prior to the push operation of the push button;

FIG. 3A is a view that shows a more detailed structure of FIG. 3, illustrating the state after the push operation of the push button or the state before the return operation;

FIG. 4 is a view as viewed from the arrow IV of FIG. 3, showing a bottom plan view of pairs of contacts in the contact housing case as viewed from below;

FIG. 5 is a schematic structural diagram of the push button switch of FIG. 1, illustrating the state prior to the push operation of the push button or the state after the return operation thereof;

FIG. 6 is a schematic structural diagram of the push button switch of FIG. 1, illustrating the state in the middle of the push operation of the push button or the state in the middle of the return operation of the push button;

FIG. 7 is a schematic structural diagram of the push button switch of FIG. 1, illustrating the state in the middle of the push operation of the push button or the state in the middle of the return operation of the push button;

FIG. 8 is a schematic structural diagram of the push button switch of FIG. 1, illustrating the state in the middle of the push operation of the push button or the state in the middle of the return operation of the push button;

FIG. 9 is a is a schematic structural diagram of the push button switch of FIG. 1, illustrating the state after the push operation of the push button or the state before the return operation of the push button;

FIG. 10 is a partially enlarged view of FIG. 8, illustrating the engagement state of the protruding portion (first engagement portion) provided on the side of the push button with the engagement member (second engagement portion) provided on the side of the holding case of the push button in the middle of the return operation of the push button;

FIG. 11 is a view for explain a force that acts on the engagement member on the side of the holding case for the push button in FIG. 10;

FIG. 12 is a view for explaining a force that acts on the engagement member on the side of the holding case for the push button when the return operation of the push button progresses from the state of FIG. 11;

FIG. 13 shows the engagement state in which the protruding portion on the side of the push button is engaged with the engagement member on the side of the holding case for the push button in the middle of the return operation of the push button of a prior-art push button switch, which corresponds to FIG. 10 of the first embodiment of the present invention;

FIG. 14 is a view showing a force acting on the engagement member on the side of the holding case for the push button in FIG. 13, which corresponds to FIG. 11 of the first embodiment of the present invention;

FIG. 15 is a view for explaining a force that acts on the engagement member on the side of the holding case for the push button when the return operation of the push button progresses from the state of FIG. 14, which corresponds to FIG. 12 of the first embodiment of the preset invention;

FIG. 16 is a general perspective view of the push button switch with a cutaway according to the second embodiment of the present invention, illustrating the state after the push operation of the push button;

FIG. 17 shows the state in the middle of the return operation of the push button of the push button switch of FIG. 16;

FIG. 18 is a partial enlarged view of the push button switch of FIG. 17, showing a load imparted to the engagement surface;

FIG. 19 is a view enlarging the load imparted to the engagement surface in FIG. 18;

FIG. 20 is a view enlarging the load imparted to the engagement surface of a prior-art push button switch, which corresponds to FIG. 19 of the second embodiment of the present invention;

FIG. 21 shows the state after the return operation of the push button of the push button switch of FIG. 16;

FIG. 22 is a partially enlarged view of the push button switch according the first alternative embodiment of the present invention, illustrating the engagement state between two protruding portions (first engagement portion) provided on the side of the push button and two engagement members (second engagement portion) provided on the side of the holding case for the push button in the middle of the return operation of the push button;

FIG. 23 shows the state after the return operation of the push button of the push button switch of FIG. 22;

FIG. 24 is a schematic structural view of the push button switch according to the second alternative embodiment of the present invention, showing the state prior to the return operation of the push button;

FIG. 25 shows the state in the middle of the return operation of the push button of the push button switch of FIG. 24;

FIG. 26 shows the state after the return operation of the push button of the push button switch of FIG. 24;

FIG. 27 is a partially enlarged view of the push button switch according the third alternative embodiment of the present invention, showing the state prior to the push operation of the push button;

FIG. 28 shows the state after the push operation of the push button or the state before the return operation of the push button of the push button switch of FIG. 27;

FIG. 29 shows the state in the middle of the return operation of the push button of the push button switch of FIG. 27;

FIG. 30 shows the state in the middle of the return operation of the push button of the push button switch of FIG. 27;

FIG. 31A is a view for explaining the push button switch according to the fourth alternative embodiment of the present invention, schematically showing the arrangement position of a pair of engagement members (FIG. 31B) provided on the side of the holding case for the push button;

FIG. 31B is a view for explaining the push button switch according to the fourth alternative embodiment of the present invention and a partially enlarged view of the push button switch, showing the state prior to the return operation of the push button;

FIG. 32A is a view for explaining the push button switch according to the fourth alternative embodiment of the present invention, schematically showing the arrangement position of another pair of engagement members (FIG. 32B) provided on the side of the holding case for the push button;

FIG. 32B is a view for explaining the push button switch according to the fourth alternative embodiment of the present invention and a partially enlarged view of the push button switch, showing the state prior to the return operation of the push button;

FIG. 33 is a view for explaining the push button switch according to the fifth alternative embodiment of the present invention, showing the state prior to the return operation of the push button;

FIG. 34 shows the state in the middle of the return operation of the push button of the push button switch of FIG. 33;

FIG. 35 shows the state in the middle of the return operation of the push button of the push button switch of FIG. 33;

FIG. 36 shows the state after the return operation of the push button of the push button switch of FIG. 33;

FIG. 37 is a partial perspective view of the operation unit of the push button switch with a cut away according to the sixth alternative embodiment of the present invention, showing the state prior to the return operation (rotational angle is 0 degrees) of the push button;

FIG. 38 is a partial view for explaining the details of the respective parts of the push button switch of FIG. 37;

FIG. 39 is a partial view for explaining the details of the shaft portion of the push button switch of FIG. 37;

FIG. 40 is a partial view for explaining the details of the shaft portion of the push button switch of FIG. 37, as viewed from arrow XL of FIG. 39;

FIG. 41 is a bottom plan view of the push button switch of FIG. 38, as viewed from arrow XLI of FIG. 38;

FIG. 42 illustrates the state in the middle of the return operation (rotational angle is 30 degrees) by the turn reset of the push button of the push button switch of FIG. 37;

FIG. 43 illustrates the state in the middle of the return operation (rotational angle is 45 degrees) by the turn reset of the push button of the push button switch of FIG. 37;

FIG. 44 illustrates the state in the middle of the return operation (rotational angle is 90 degrees) by the turn reset of the push button of the push button switch of FIG. 37;

FIG. 45 is a view showing a change in the engagement state between the engagement member and the protruding portion in time-series manner when turn-resetting the push button of the push button switch of FIG. 37;

FIG. 46 is a view showing a change in the engagement state between the engagement member and the protruding portion in time-series manner when turn-resetting the push button of the push button switch of FIG. 37;

FIG. 47 is a view showing a change in the engagement state between the engagement member and the protruding portion in time-series manner when turn-resetting the push button of the push button switch of FIG. 37;

FIG. 48 is a view showing a change in the engagement state between the engagement member and the protruding portion in time-series manner when turn-resetting the push button of the push button switch of FIG. 37;

FIG. 49 is a view for explaining a change in inclined angles of the upper-side inclined surface of the protruding portion at the time of engagement with the engagement member in the push button switch of FIG. 37;

FIG. 50 is a partial perspective view of the operation unit of the push button switch with a cut away according to the seventh alternative embodiment of the present invention, showing the state prior to the return operation of the push button;

FIG. 51 is a partial view for explaining the details of the respective parts of the push button switch of FIG. 50;

FIG. 52 is a partial view for explaining the details of the shaft portion of the push button switch of FIG. 50;

FIG. 53 is a partial view for explaining the details of the shaft portion of the push button switch of FIG. 50, as viewed from arrow LIII of FIG. 52;

FIG. 54 is a bottom plan view of the push button switch of FIG. 51, as viewed from arrow LIV of FIG. 51;

FIG. 55 illustrates the state in the middle of the return operation by a pull-reset of the push button of the push button switch of FIG. 50;

FIG. 56 illustrates the state in the middle of the return operation by the pull-reset of the push button of the push button switch of FIG. 50;

FIG. 57 illustrates the state in the middle of the return operation by the pull-reset of the push button of the push button switch of FIG. 50; and

FIG. 58 illustrates the state after the return operation by the pull-reset of the push button of the push button switch of FIG. 50.

### BEST MODE FOR CARRYING OUT THE INVENTION

Embodiments of the present invention will be described below in reference to the accompanying drawings.

### First Embodiment

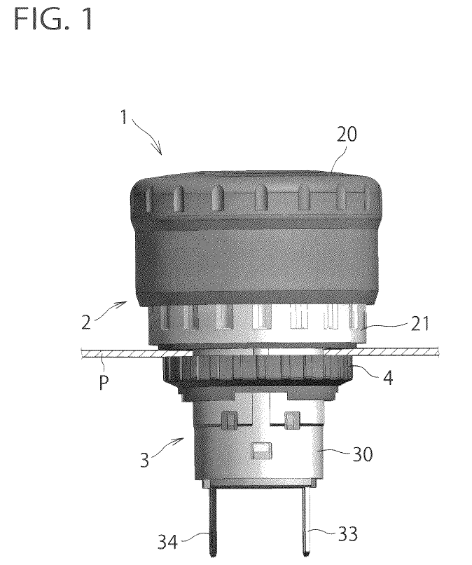

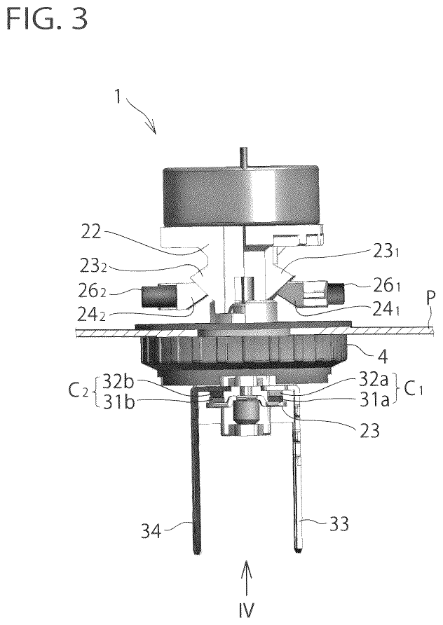

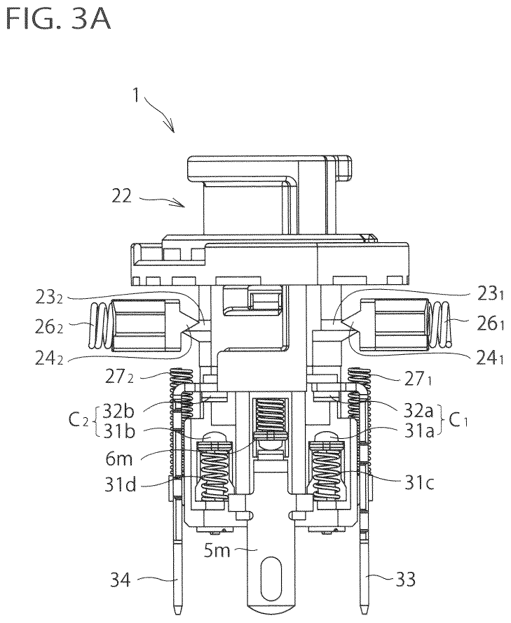

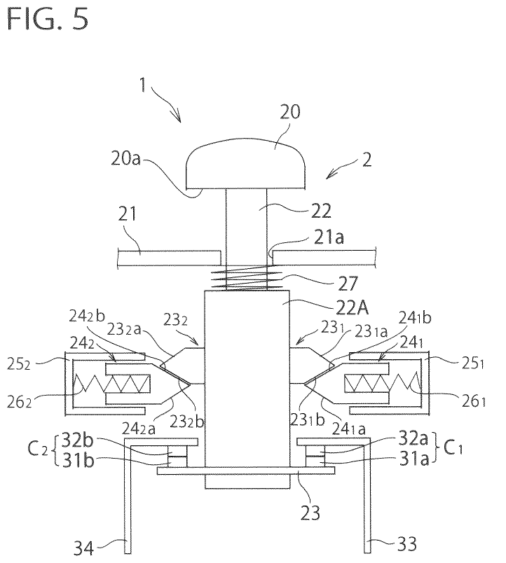

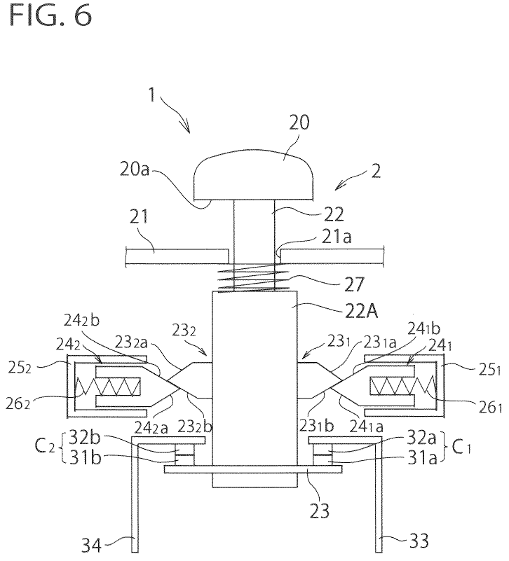

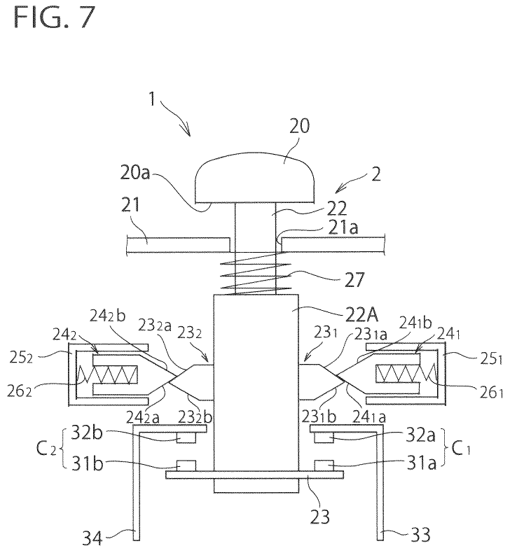

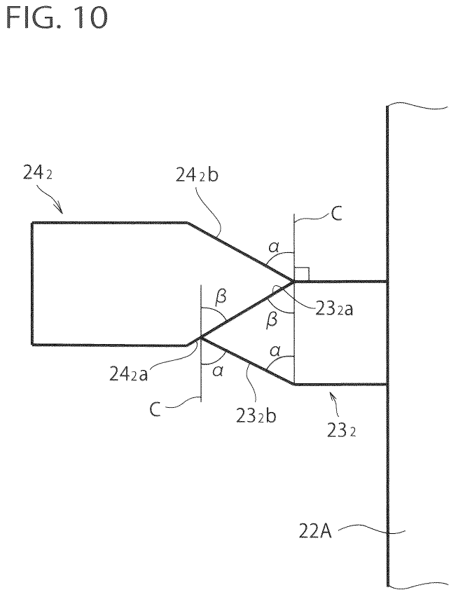

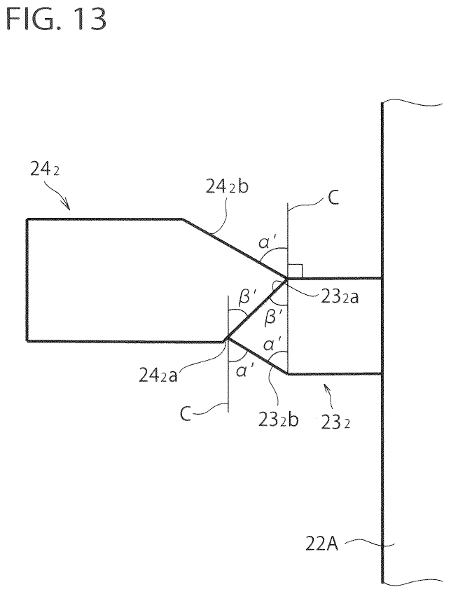

FIGS. 1 to 12 show a push button switch according to a first embodiment of the present invention. FIGS. 13 to 15 show a structure of a prior-art push button switch that respectively corresponds to FIGS. 10 to 12 of the present embodiment. Also, FIGS. 5 to 9 schematically show a general structure of the push button switch. FIGS. 5 and 6 show an ON state of a contact of the push button switch and FIGS. 7 to 9 show an OFF state of a contact of the push button switch. In addition, FIG. 3A is a view showing the more detailed structure of FIG. 3, illustrating the state after the push operation of the push button or the state before the return operation of the push button (FIG. 3 shows the state prior to the push operation of the push button).

As shown in FIG. 1, a push button switch 1 comprises an operation unit 2 that includes a push button 20 which is push-operatable and return-operatable by an operator and a holding case 21 to hold the push button 20, and a contact unit 3 that is detachably fitted to the operation unit 2 and that has a contact housing case 30 which houses contacts (noted below). The push button switch 1 is adapted to be fitted to a panel P of a machine, a control equipment and the like through a lock nut 4 that is screwed into a threaded portion (not shown) of the operation unit 2.

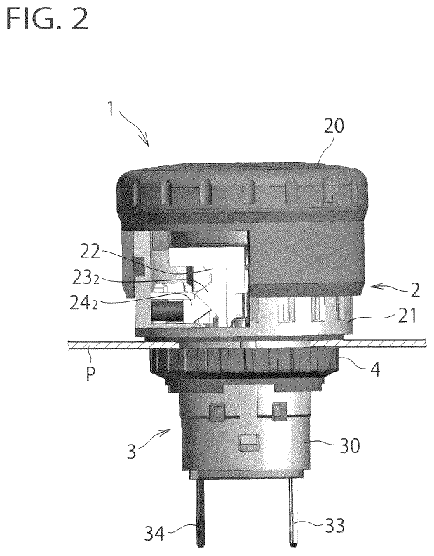

As shown in FIG. 5 (see FIGS. 2 to 4), the push button 20 has a shaft portion 22 that extends from a back surface 20a of the push button 20 through a though hole 21a of the holding case 21. The shaft portion 22 has a large-diameter part 22A integrally formed thereto. The large-diameter part 22A has a conductive plate 23 fitted to a distal end thereof and movable contacts 31a, 31b are respectively fitted to both ends of the conductive plate 23. The movable contacts 31a, 31b are adapted to move in an axial direction (i.e. an up-down direction in FIG. 5) along with the large-diameter part 22A. That is, the respective movable contacts 31a, 31b are movable in a push-operational direction (i.e. a downward direction in FIG. 5) of the push button 20 and a return-operational direction (i.e. an upward direction in FIG. 5) opposite the push-operational direction.

At positions that face the respective movable contacts 31a, 31b in the up-down direction, fixed contacts 32a, 32b are respectively provided that are contactable and separatable relative to the movable contacts 31a, 31b. The fixed contacts 32a, 32b are respectively fitted to a respective end of generally L-shaped conductive members 33, 34 (see FIGS. 3 and 3A). A distal end of the respective conductive members 33, 34 extends to an outside of the housing case 30 of the push button switch 1 (see FIGS. 1 and 2). In the state shown in FIG. 5, the fixed contacts 32a, 32b are respectively in contact with the corresponding movable contacts 31a, 31b. At this time, the movable contacts 31a, 31b are respectively biased toward the corresponding fixed contacts 32a, 32b through a biasing force of the coil spring 31c, 31d (FIG. 3A) and elastically contacted with the movable contacts 32a, 32b.

The movable contact 31a and the corresponding fixed contact 32a constitute a first pair of contacts C₁, and the movable contact 31b and the corresponding fixed contact 32b constitute a second pair of contacts C₂. The first pair of contacts C₁ are disposed on one side of the shaft portion 22A of the push button 20 and the second pair of contacts C₂ are disposed on the other side of the shaft portion 22A of the push button 20. The first pair of contacts C₁ and the second pair of contacts C₂ are transferred to an open state by the push operation of the push button 20 (see FIGS. 7 to 9) and to a contact state by the return operation of the push button 20 (see FIGS. 5 and 6).

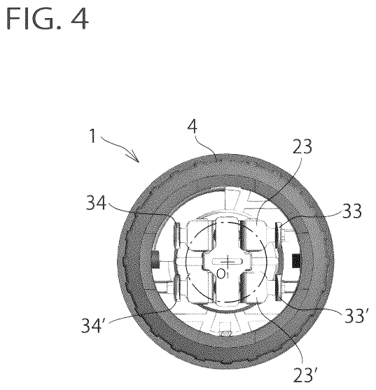

In this exemplification, the conductive plate 23 is also disposed at the position out of the page in FIG. 5 (see the conductive plate 23′ in FIG. 4) and a pair of movable contacts (not shown) are also fitted to the conductive plate 23′. Similarly, the conductive plates 33, 34 are also disposed at the position into the page in FIG. 5 (see the conductive plates 33′, 34′ in FIG. 4) and a pair of fixed contacts (not shown) that are contactable and separatable relative to the respective movable contacts of the conductive plate 23′ are also fitted to the conductive plates 33′, 34′. These movable contacts and the fixed contacts are also respectively disposed on one side and the other side of the shaft portion 22A of the push button 20 inside the housing case 30 and respectively constitute a pair of contacts. Therefore, in this example, four pairs of contacts are provided.

Also, in the example shown in FIG. 3A, there are provided two opening biasing springs 27₁, 27₂ as opening biasing means that respectively bias the first and second pairs of contacts C₁, C₂ in the opening direction. As shown in FIG. 3A, the respective opening biasing springs 27₁, 27₂ are disposed outside the first and second pairs of contacts C₁, C₂ (that is, on the outer-circumferential side inside the housing case 30). As shown in a dash-and-dot line in FIG. 4, the first and second pairs of contacts C₁, C₂ (the same is true of the other contacts) are disposed on a circumference with its center positioned at point O₁ composing the center of the switch and the respective opening biasing springs 27₁, 27₂ are disposed at a radially outward position (i.e. outside the circumference) of the first and second pairs of contacts C₁, C₂. In addition, in the example shown in FIG. 3A, a fixed terminal 5m and a movable terminal 6m are also provided that constitute a monitor contact to monitor an operation condition of the push button switch 1.

In such a way, by providing two (or more than two) opening biasing springs, a sufficient biasing force of the opening biasing springs can be applied to a plurality of contacts in the opening biasing direction and stability at the time of contacting/opening of the respective contacts can be improved. Also, a load necessary for safety Potential® (applying a load in the opening direction in which contacts are in a non-contact state) can be divided at a plurality of positions around the center of the switch, thereby producing an effect for a load duplication (or multiplexing) in the opening direction. Moreover, since the opening biasing springs are disposed at positions radially outside the respective contacts that are located radially away from the center of the switch, stability at the time of contacting/opening of the respective contacts can be further improved and the push button switch can be made shorter thus achieving a push button switch of a short length.

As shown in FIG. 5 (see FIGS. 2 to 4), the shaft portion 22A of the push button 20 has a pair of protruding portions (first engaging portions) 23₁, 23₂ that protrude radially outwardly and that is integrated with the shaft portion 22A.

The protruding portions 23₁, 23₂ are disposed on opposite sides across the shaft portion 22A, that is, 180 (or approximately 180) degrees apart from each other circumferentially around the shaft portion 22A. The protruding portion 23₁ has a pair of inclined surfaces 23₁a, 23₁b at a distal end thereof, which are spaced away in the axial direction of the shaft portion 22A and which intersect with each other at the distal end, and thus the protruding portion 23₁ has a distal end portion of a generally triangular-shape. Likewise, the protruding portion 23₂ has a pair of inclined surfaces 23₂a, 23₂b at a distal end thereof, which are spaced away in the axial direction of the shaft portion 22A and which intersect with each other at the distal end, and thus the protruding portion 23₂ has a distal end portion of a generally triangular-shape.

As shown in FIG. 5 (see FIGS. 2 and 3), at positions corresponding to the respective protruding portions 23₁, 23₂ of the shaft portion 22A on the side of the holding case 21 of the push button 20, engagement members (second engagement portion) 24₁, 24₂ are provided. The respective engagement members 24₁, 24₂ are circumferentially disposed 180 (or approximately 180) degrees apart from each other on an inner circumferential side of the holding case 21 (i.e. outer circumferential side of the shaft portion 22A) and supported slidably by guide portions 25₁, 25₁ respectively. The respective engagement members 24₁, 24₂ are provided movably toward and away from the corresponding protruding portions 23₁, 23₂. Inside the guide portions 25₁, 25₂, springs (biasing member) 26₁, 26₂ are respectively provided contractedly. An end of the respective springs 26₁, 26₂ press-contacts a sidewall of the respective guide portions 25₁, 25₂ and the other end of the respective springs 26₁, 26₂ press-contacts the respective engagement members 24₁, 24₂. Thereby, the respective engagement members 24₁, 24₂ are biased toward the shaft portion 22A at all times.

The engagement member 24₁ has a pair of inclined surfaces (first and second inclined surfaces) 24₁b, 24₁a at a distal end thereof, which are spaced away in the axial direction of the shaft portion 22A and which intersect with each other at the distal end, and thus the engagement member 24₁ has a distal end portion of a generally triangular-shape. Likewise, the engagement member 24₂ has a pair of inclined surfaces (first and second inclined surfaces) 24₂b, 24₂a at a distal end thereof, which are spaced away in the axial direction of the shaft portion 22A and which intersect with each other at the distal end, and thus the engagement member 24₂ has a distal end portion of a generally triangular-shape.

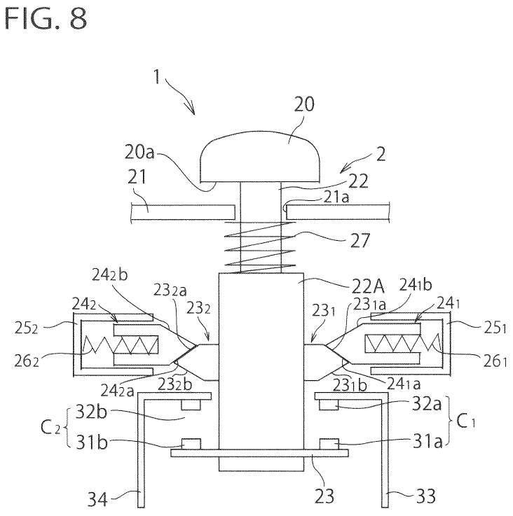

The respective engagement members 24₁, 24₂ and the respective protruding portions 23₁, 23₂ are detachably engageable with each other through the corresponding inclined surfaces. In the state shown in FIGS. 5 and 6, the respective inclined surfaces 23₁b, 23₂b of the protruding portions 23₁, 23₂ are engaged with the respective inclined surfaces (first inclined surface) 24₁b, 24₂b of the engagement members 24₁, 24₂. In the state shown in FIGS. 7 and 8, the respective inclined surfaces 23₁a, 23₂a of the protruding portions 23₁, 23₂ are engaged with the respective inclined surfaces (second inclined surface) 24₁a, 24₂a of the engagement members 24₁, 24₂. At the time of engagement of the respective inclined surfaces 23₁b, 23₂b of the protruding portions 23₁, 23₂ with the respective inclined surfaces (first inclined surface) 24₁b, 24₂b of the engagement members 24₁, 24₂, since an elastic repulsive force of the respective springs 26₁, 26₂ is imparted to the engagement members 24₁, 24₂, the engagement members 24₁, 24₂ are elastically engaged with the respective protruding portions 23₁, 23₂ to apply a pressing force to the respective protruding portions 23₁, 23₂.

Accordingly, the springs 26₁, 26₂ and the engagement members 24C, 24₂ function as a load means that puts a load to the shaft portion 22A (and thus the push button 20) through the protruding portions 23₁, 23₂. Also, in FIGS. 6 and 7, mutual engagement surfaces between the engagement members 24₁, 24₂ and the protruding portions 23₁, 23₂ are switched and the engagement state is thus changed. At the time, the load by the load means is released.

Here, we will explain respective inclined angles of the inclined surfaces 23₁a, 23₂a of the protruding portions 23₁, 23₂ and the inclined surfaces 24₁a, 24₂a of the engagement members 24₁, 24₂ in reference to FIG. 10 which is a partially enlarged view of FIG. 8.

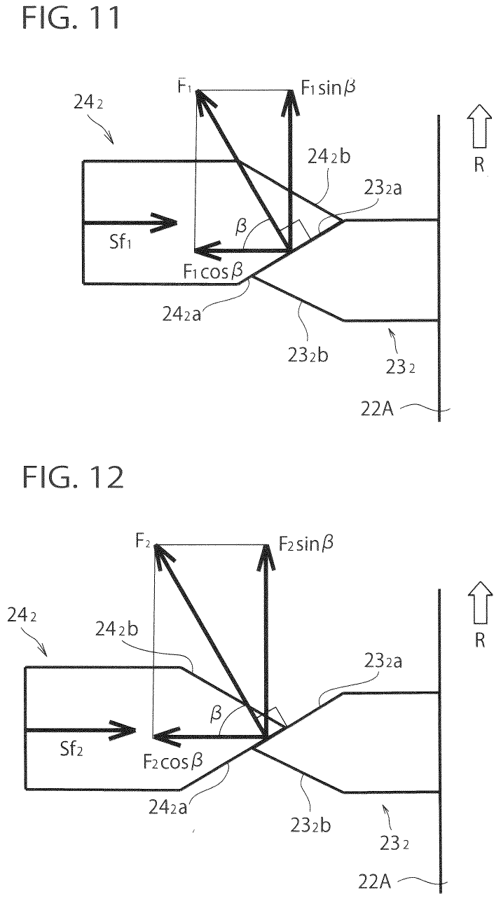

FIG. 10 is an enlarged view of a left-side protruding portion 23 and the engagement portion 24₂ in FIG. 8 and shows the state in which the inclined surface 23₂a of the protruding portion 23₂ is in a surface contact and engagement with the inclined surface 24₂a of the engagement portion 24₂. Also, in FIG. 10, a reference character C indicates a direction coinciding with the axial direction of the shaft portion 22A and in this embodiment, the axial line C is disposed at the apex of the distal end portion of a triangular-shape (that is, the intersecting point of the respective inclined surfaces) of the protruding portion 23₂ and the engagement portion 24₂. In addition, sine explanations below regarding FIG. 10 (and explanations of FIGS. 11 and 12 related to those of FIG. 10) are equally applicable to the right-side protruding portion 23₁ and the engagement portion 24₁ in FIG. 8, we will here explain only the left-side protruding portion 23₂ and the engagement portion 24₂ in FIG. 8.

As shown in FIG. 10, the upper-side inclined surface (first inclined surface) 24₂b of the engagement member 24₂ forms an inclined angle α on an acute-angle side relative to the axial line C (that is, in this exemplification, the angle is measured in the counterclockwise direction from the axial line C that passes through the apex). The lower-side inclined surface (second inclined surface) 24₂a of the engagement member 24₂ forms an inclined angle β on an acute-angle side relative to the axial line C (that is, in this exemplification, the angle is measured in the clockwise direction from the axial line C that passes through the apex). At this juncture, preferably, α and β are set as follows:

$$α = 60 ° \\ 50 ° < β < 70 °$$

In addition, as a value of g, more preferably, β is set as follows:

β=60°

Here, an example of β=60° is shown.

At this juncture, as can be seen from FIG. 10, an inclined angle on the acute-angle side between the upper-side inclined surface 23₂a of the protruding portion 23₂ and the axial line C passing through the apex (that is, the angle measured in the clockwise direction from the axial line C) is equal to β. Also, an inclined angle on the acute-angle side between the lower-side inclined surface 23₂b of the protruding portion 23₂ and the axial line C (that is, the angle measured in the counterclockwise direction from the axial line C) is equal to α, because at the time of the push operation of the push button 20, the lower-side inclined surface 23₂b of the protruding portion 23₂ is in surface contact and engagement with the upper-side inclined surface (first inclined surface) 24₂b of the engagement portion 24₂ (see FIG. 5).

Next, FIGS. 11 and 12 show a change in the state of engagement between the protruding portion 23₂ and the engagement member 24₂ during the return operation of the push button 20 in time-series manner. In the respective drawings, an open arrow R indicates the direction of movement of the shaft portion 22A during the return operation of the push button 20. As the return operation of the push button 20 progresses, the engagement state between the protruding portion 23₂ and the engagement member 24₂ changes from FIG. 11 to FIG. 12.

As shown FIG. 11, when the return operation of the push button 20 starts, the shaft portion 22A begins to move in the direction of arrow R along with the push button 20 and a pressing load is thus applied from the inclined surface 23₂a of the protruding portion 23₂ of the shaft portion 22A to the second inclined surface 24₂a of the engagement member 24₂. When this pressing load is designated as F₁, the pressing load Fj is applied to the second inclined surface 24₂a of the engagement member 24₂ in a vertical direction.

Now, when the pressing load F₁ is resolved into the axial line C direction of the shaft portion 22A (i.e. the return-operational direction of the push button 20) and a direction perpendicular thereto, a return-operational component force in the return-operational direction and a perpendicular component force in the direction perpendicular to the return-operational direction are designated as follows as can be seen from FIG. 11:

$$( The return - operational component force ) = {F}_{1} sin β \qquad ( 1 )$$

$$( The perpendicular component force ) = {F}_{1} cos β \qquad ( 2 )$$

The above-mentioned perpendicular component force acts onto the engagement member 24₂ in the direction that the engagement member 24₂ is pushed back to the left in FIG. 11 against the elastic repulsive force Sf₁ of the spring 26₂.

Here, as mentioned above, β satisfies an inequality, 50°<β<70° (specifically, β=60°).

sin β>cos β

### Therefore,

$${F}_{1} sin β > {F}_{1} cos β \qquad ( 3 )$$

Due to (1) to (3),

$$( The return - operational component force ) > ( The perpendicular component force ) \qquad ( 4 )$$

As the shaft portion 22A moves in the direction of arrow R along with the return operation of the push button 20, a pressing load gradually becomes greater that is applied from the inclined surface 23₂a of the protruding portion 23₂ of the shaft portion 22A to the second inclined surface 24₂a of the engagement member 24₂.

As shown in FIG. 12, when an increased pressing load F₂ is resolved into the axial C direction of the shaft portion 22A (i.e. the return-operational direction of the push button 20) and a direction perpendicular thereto, a return-operational component force in the return operational direction and a perpendicular component force in the direction perpendicular thereto are indicated as follows as can be seen from FIG. 12 (similar to the case of FIG. 11):

(The return-operational component force)=F₂ sin β (5)

(The perpendicular component force)=F₂ cos β (6)

The above-mentioned perpendicular component force acts onto the engagement member 24₂ in the direction that the engagement member 24₂ is pushed back to the left in FIG. 12 against the elastic repulsive force Sf₂ of the spring 26₂. With the increase of the pressing load F₂, the above perpendicular component force increases as well and the engagement member 24₂ thus moves to the left in FIG. 12. Thereby, an engagement length in an inclined direction between the inclined surface 23₂a of the protruding portion 23₂ and the second inclined surface 24₂a of the engagement member 24₂ becomes shorter (that is, a contact area is decreased). Also, as the engagement member 24₂ moves to the left in FIG. 12, the deformation volume (i.e. elastic contraction volume) of the spring 26₂ is increased and an elastic repulsive force Sf₂ of the spring 26₂ is thus increased.

Here, as mentioned above, β satisfies an inequality, 50°<β<70° (specifically, β=60°).

sin β>cos β

Therefore,

$${F}_{1} sin β > {F}_{1} cos β \qquad ( 7 )$$

Due to (5) to (7),

$$( The return - operational component force ) > ( The perpendicular component force ) \qquad ( 8 )$$

Further,

$${F}_{2} > {F}_{1} \qquad ( 9 )$$

Therefore,

$${F}_{2} sin β > {F}_{1} sin β \qquad ( 10 )$$

When the return operation starts, the pressing load that acts onto the second inclines surface 24₂a of the engagement member 24₂ from the inclined surface 23₂a of the protruding portion 23₂ of the shaft portion 22A gradually becomes greater (see the equation (9)). Therefore, the equation (10) indicates that when the return operation starts the return operational component force in the return operational direction of the push button 20 gradually becomes greater. Such a return operational component force becomes the largest immediately before the engagement state between the inclined surface 23₂a of the protruding portion 23₂ and the second inclined surface 24₂a of the engagement member 24₂ becomes disengaged. That is, at this time, the load of the engagement member 24₂ on the protruding portion 23₂ becomes the largest.

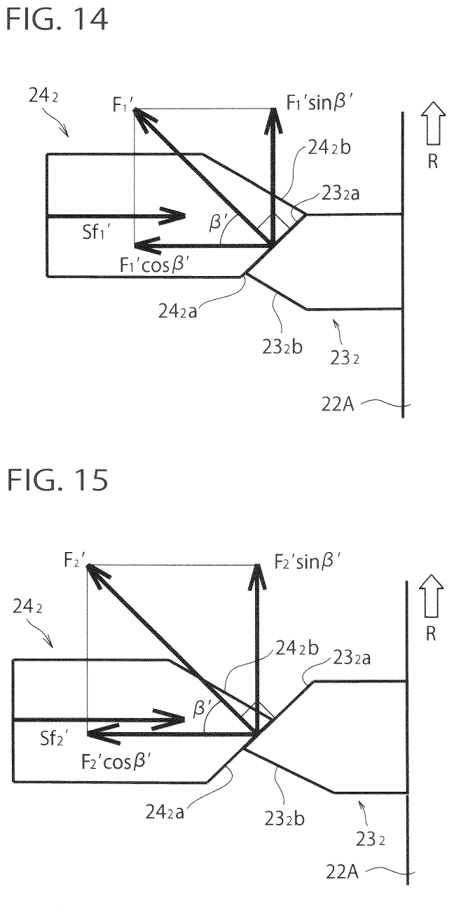

On the other hand, in a prior-art push button switch, an engagement state between a protruding portion of a shaft portion of a push button and an engagement member that engages with the protruding portion is shown in FIGS. 13 to 15. FIG. 13 corresponds to FIG. 10 of the first embodiment of the present invention and FIGS. 14, 15 correspond respectively to FIGS. 11 to 12 of the first embodiment of the present invention. In the respective drawings, like reference numbers indicate identical or functionally similar elements.

FIGS. 13 to 15 show the state in which the inclined surface 23₂a of the protruding portion 23₂ is in surface contact and engagement with the inclined surface 24₂a of the engagement member 24₂. As shown in FIG. 13, the upper-side inclined surface (first inclined surface) 24₂b of the engagement member 24₂ forms an inclined angle α′ on an acute-angle side relative to the axial line C passing through the apex (that is, the angle is measured in the counterclockwise direction from the axial line C that passes through the apex). The lower-side inclined surface (second inclined surface) 24₂a of the engagement member 24₂ forms an inclined angle β′ on an acute-angle side relative to the axial line C passing through the apex (that is, the angle is measured in the clockwise direction from the axial line C). In this example, α′ and β′ are set as follows:

$${α}^{′} = 60 ° = α \\ {β}^{′} = 45 °$$

At this juncture, an inclined angle on the acute-angle side between the upper-side inclined surface 23₂a of the protruding portion 23₂ and the axial line C passing through the apex (that is, the angle measured in the clockwise direction from the axial line C) is equal to β′. Also, an inclined angle on the acute-angle side between the lower-side inclined surface 23₂b of the protruding portion 23₂ and the axial line C passing through the apex (that is, the angle measured in the counterclockwise direction from the axial line C) is equal to α′, because at the time of the push operation of the push button 20, the lower-side inclined surface 23₂b of the protruding portion 23₂ is in surface contact and engagement with the upper-side inclined surface (first inclined surface) 24₂b of the engagement member 24₂.

Next, FIGS. 14 and 15 show a change in the state of engagement of the protruding portion 23 with the engagement member 24₂ during the return operation of the push button 20 in time-series manner. As the return operation of the push button 20 progresses, the engagement state between the protruding portion 23₂ and the engagement member 24₂ changes from FIG. 14 to FIG. 15.

As shown FIG. 14, when the return operation of the push button 20 starts, the shaft portion 22A begins to move in the direction of arrow R along with the push button 20 and a pressing load is thus applied from the inclined surface 23₂a of the protruding portion 23₂ of the shaft portion 22A to the second inclined surface 24₂a of the engagement member 24₂. When this pressing load is designated as F₁′, the pressing load F₁′ is applied to the second inclined surface 24₂a of the engagement member 24₂ in a vertical direction.

Now, when the pressing load F₁′ is resolved into the axial line direction of the shaft portion 22A (i.e. the return-operational direction of the push button 20) and a direction perpendicular thereto, a return-operational component force in the return-operational direction and a perpendicular component force in the direction perpendicular to the return-operational direction are designated as follows as can be seen from FIG. 14:

$$( The return - operational component force ) = {F}_{1}^{′} sin {β}^{′} \qquad ( 11 )$$

$$( The perpendicular component force ) = {F}_{1}^{′} cos {β}^{′} \qquad ( 12 )$$

The above-mentioned perpendicular component force acts onto the engagement member 24₂ in the direction that the engagement member 24₂ is pushed back to the left in FIG. 14 against the elastic repulsive force Sf₁′ of the spring 26₂.

Here, as mentioned above, β′ satisfies an equation, β′=45°,

sin β′=cos β′

Therefore,

$${F}_{1}^{′} sin {β}^{′} = {F}_{1}^{′} cos {β}^{′} \qquad ( 13 )$$

Due to (11) to (13),

$$( The return - operational component force ) = ( The perpendicular component force ) \qquad ( 14 )$$

As the shaft portion 22A moves in the direction of arrow R with the return operation of the push button 20, a pressing load gradually becomes greater that is applied from the inclined surface 23₂a of the protruding portion 23₂ of the shaft portion 22A to the second inclined surface 24₂a of the engagement member 24₂.

As shown in FIG. 15, when an increased pressing load F₂′ is resolved into the axial direction of the shaft portion 22A (i.e. the return operational direction of the push button 20) and a direction perpendicular thereto, a return operational component force in the return operational direction and a perpendicular component force in the direction perpendicular thereto are indicated as follows as can be seen from FIG. 15 (similar to the case of FIG. 14):

(The return-operational component force)=F₂′ sin β′ (15)

(The perpendicular component force)=F₂′ cos β′ (16)

The above-mentioned perpendicular component force acts onto the engagement member 24₂ in the direction that the engagement member 24₂ is pushed back to the left in FIG. 15 against the elastic repulsive force Sf₂′ of the spring 26₂. With the increase of the pressing load F₂′, the above perpendicular component force increases as well and the engagement member 24₂ thus moves to the left in FIG. 15. Thereby, an engagement length in an inclined direction between the inclined surface 23₂a of the protruding portion 23₂ and the second inclined surface 24₂a of the engagement member 24₂ becomes shorter (that is, a contact area is decreased). Also, as the engagement member 24₂ moves to the left in FIG. 15, the deformation volume (i.e. elastic contraction volume) of the spring 26₂ is increased and an elastic repulsive force Sf₂′ of the spring 26₂ is thus increased.

Here, as mentioned above, β′ is satisfied an equation, β′=45° Hence,

sin β′=cos β′

Therefore,

$${F}_{2}^{′} sin {β}^{′} = {F}_{2}^{′} cos {β}^{′} \qquad ( 17 )$$

Due to (15) to (17),

(The return-operational component force)=(The perpendicular component force) (18)

Further,

$${F}_{2}^{′} > {F}_{1}^{′} \qquad ( 19 )$$

Therefore,

$${F}_{2}^{′} sin {β}^{′} > {F}_{1}^{′} sin {β}^{′} \qquad ( 20 )$$

When the return operation is started, the pressing load that acts onto the second inclined surface 24₂a of the engagement member 24₂ from the inclined surface 23₂a of the protruding portion 23₂ of the shaft portion 22A gradually becomes greater (see the equation (19)). Therefore, the equation (20) indicates that when the return operation is started the return operational component force in the return operational direction of the push button 20 gradually becomes greater. Such a return operational component force becomes the largest immediately before an engagement state between the inclined surface 23₂a of the protruding portion 23₂ and the second inclined surface 24₂a of the engagement member 24₂ becomes disengaged.

As mentioned above, in the first embodiment, β satisfies an inequality, 50°<β<70° (specifically, β=60°) and in the prior art, β′ satisfies an equation, β′=45°.

Therefore,

$$sin β > sin {β}^{′} \qquad ( 21 )$$

Hence, even in the case that a pressing load of the same size is applied from the inclined surface 23₂a of the protruding portion 23₂ to the second inclined surface 24₂a of the protruding member 24₂ (that is, in FIGS. 11 to 15, F₁=F₁′ or F₂=F₂′),

$${F}_{1} sin β > {F}_{1}^{′} sin {β}^{′} \qquad ( 22 )$$

is satisfied. Alternatively,

$${F}_{2} sin β > {F}_{2}^{′} sin {β}^{′} \qquad ( 23 )$$

is satisfied.

In this way, according to the first embodiment of the present invention, when a pressing load is applied from the inclined surface 23₂a of the protruding portion 23₂ of the shaft portion 22A to the second inclined surface 24₂a of the protruding member 24₂ during the return operation of the push button 20, as the pressing load is resolved into the return operational direction and the direction perpendicular thereto, as shown in the equations (4) and (8), the return-operational component force in the return operational direction is greater than the vertical component force perpendicular to the return-operational component force (see FIGS. 11 and 12) and also greater than a return-operational component force in the return operational direction of a prior-art push button switch (see FIGS. 11 to 14, equations (22) to (23)).

Therefore, according to the present embodiment, during the return operation of the push button 20, the return-operational component force that acts in the return operational direction of the push button 20 is increased and an increased return operational component force is applied to the push button 20 in the return operational direction.

Also, in the push button switch 1 shown in FIG. 5, the opening biasing spring 27 is provided at the shaft portion 22, as the opening biasing means that biases the first and second pairs of contacts C₁, C₂ in the opening direction. The opening biasing spring 27 is fitted to the shaft portion 22 of the push button switch 1 in a contracted state and an end of the opening biasing spring 27 press-contacts the shaft portion 22A of a large diameter. Thereby, the push button 20 is biased at all times in the press direction by the action of the spring force on the shaft portion 22A. Therefore, the opening biasing spring 27 assists the push operation by an operator during the push operation of the push button 20 and acts against the return operation by the operator during the return operation of the push button 20.

Next, the operation of the above-mentioned push button switch 1 will be explained in reference to FIGS. 5 to 9.

At the time of the push operation of the push button 20 of the push button switch 1, the operator presses the push button 20 from the state prior to the push operation of the push button 20 shown in FIG. 5 (at this juncture, the first and second pairs of contacts C₁, C₂ are ON). Then, the shaft portion 22A moving along with the push button 20 is pushed in downwardly. At this time, a pressing load is applied to the first inclined surfaces 24₁b, 24₂b of the respective engagement members 24₁, 24₂ from the lower-side inclined surfaces 23₁b, 23₂b of the respective protruding portions 23₁, 23₂ of the shaft portion 22A. By the action of this pressing load, as shown in FIG. 6, the respective engagement members 24₁, 24₂ gradually contract in the respective guide portions 25₁, 25₂ against the spring force of the respective springs 26₁, 26₂.

From the state shown in FIG. 6, when the shaft portion 22A is further pushed in downwardly along with the push button 20, the respective engagement members 24₁, 24₂ further contract in the respective guide portions 25₁, 25₂ against the spring force of the respective springs 26₁, 26₂. Thereby, the engagement state between the inclined surfaces 23₁b, 23₂b of the respective protruding portions 23₁, 23₂ and the first inclined surfaces 24₁b, 24₂b of the respective engagement members 24₁, 24₂ is disengaged. As a result, as shown in FIG. 7, the protruding portions 23₁, 23₂ climb over the engagement members 24₁, 24₂ to move downwardly. In this way, the first and second pairs of contacts C₁, C₂ are transferred to an OFF state. Also, at this juncture, a portion of the second inclined surfaces 24₁a, 24₂a of the respective engagement members 24₁, 24₂ comes into engagement with the upper-side inclined surfaces 23₁a, 23₂a of the respective protruding portions 23₁, 23₂ of the shaft portion 22A.

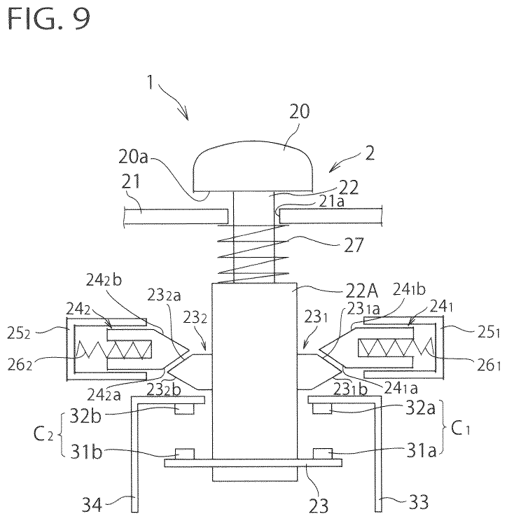

When the push button 20 is further pushed in downwardly from the state shown in FIG. 7, as shown in FIG. 8, through the engagement state in which the entire second inclined surfaces 24₁a, 24₂a of the respective engagement members 24₂, 24₂ engaged with the upper-side inclined surfaces 23₁a, 23₂a of the respective protruding portions 23₁, 23₂ of the shaft portion 22A, as shown in FIG. 9, the shaft portion 22A moves to the position at which the upper-side inclined surfaces 23₁a, 23₂a of the respective protruding portions 23₁, 23₂ is located slightly downwardly away from the second inclined surfaces 24₁a, 24₂a of the respective engagement members 24₁, 24₂. FIG. 9 shows the state in which the push operation of the push button 20 is completed.

Next, at the time of the return operation of the push button 20 of the push button switch 1, from the state after the push operation of the push button 20 shown in FIG. 9 (at this juncture, the first and second pairs of contacts C₁, C₂ are OFF), the operator pulls up the push button 20 in the direction opposite the push-in direction. Then, the shaft portion 22A moving along with the push button 20 pulled up and as shown in FIG. 8, the upper-side inclined surfaces 23₁a, 23₂a of the respective protruding portions 23₁, 23₂ of the shaft portion 22A come into contact and engagement with the second inclined surfaces 24₁a, 24₂a of the respective engagement members 24₁, 24₂.

At this juncture, as mentioned in reference to FIG. 11, a pressing load is imparted to the second inclined surfaces 24₂a, 24₂a of the respective engagement members 24₁, 24₂ from the upper-side inclined surfaces 23₁a, 23₂a of the respective protruding portions 23₁, 23₂ of the shaft portion 22A. From this state, when the push button 20 and the shaft portion 22A are further pulled up, as explained in reference to FIG. 12, the pressing load increases that acts to the second inclined surfaces 24₁a, 24₂a of the respective engagement member 24₁, 24₂ from the inclined surfaces 23₁a, 23₂a of the respective protruding portions 23₁, 23₂. Such an increased pressing load causes the engagement members 24₁, 24₂ to retract into the respective guide portions 25₁, 25₂ against the spring force of the respective springs 26₁, 26₂ (see FIG. 7). Immediately before the engagement state becomes disengaged between the inclined surfaces 23₁a, 23₂a of the respective protruding portions 23₁, 23₂ and the second inclined surfaces 24₁a, 24₂a of the respective engagement members 24₁, 24₂, the pressing load acting onto the engagement members 24₁, 24₂ from the protruding portions 23₁, 23₂ becomes the largest.

FIG. 6 shows the state in which the engagement state is disengaged between the inclined surfaces 23₁a, 23₂a of the respective protruding portions 23₁, 23₂ and the second inclined surfaces 24₁a, 24₂a of the respective engagement members 24₁, 24₂. At this juncture, the lower-side inclined surfaces 23₁b, 23₂b of the respective protruding portions 23₁, 23₂ come into engagement with the first inclined surfaces 24₁b, 24₂b of the respective engagement members 24₁, 24₂. In the middle of the movement from FIG. 7 to FIG. 6, the engagement state becomes disengaged between the inclined surfaces 23₁a, 23₂a of the respective protruding portions 23₁, 23₂ and the second inclined surfaces 24₁a, 24₂a of the respective engagement members 24₁, 24₂. As above-mentioned, immediately before the engagement state becomes disengaged, the pressing load becomes the largest that acts on the engagement members 24₁, 24₂ from the protruding portions 23₁, 23₂. Therefore, immediately after the engagement state becomes disengaged, the respective protruding portions 23₁, 23₂ start to move in the return operational direction by the maximum return-operational component force, i.e. the return-operational component force of the maximum pressing load, which is a return operational direction component of the maximum pressing load.

Thereby, immediately after the engagement state becomes disengaged between the protruding portions 23₁, 23₂ and the engagement members 24₁, 24₂, the push button 20 can move rapidly with a large acceleration in the return operational direction. Asa result, the first and second pairs of contacts C₁, C₂ can be surely prevented from causing a non-matching of contacts at the time of the return operation. In addition, after the return operation of the push button 20, the push button switch 1 is transferred to the state shown in FIG. 5.

In such a manner, in the present embodiment, the second inclined surfaces 24₁a, 24₂a of the respective engagement members 24₁, 24₂ put a load on the push button 20 at the time of the return operation of the push button 20 and then release the load and thus function as a return speed-increasing means that increases the return speed in the return operational direction of the push button 20. The inclined angle β of the respective second inclined surfaces 24₁a, 24₂a of the engagement portions 24₁, 24₂ is set to fulfill a return-speed increasing function of the push button 20. By providing such a return speed-increasing means, even in the state that at the time of the return operation of the push button 20 the opening biasing spring 27 acts against the return operation, the return operation speed of the push button 20 in the return operational direction can be increased, thereby surely preventing the first and second pairs of contacts C₁, C₂ from causing a non-matching of contacts.

### Second Embodiment

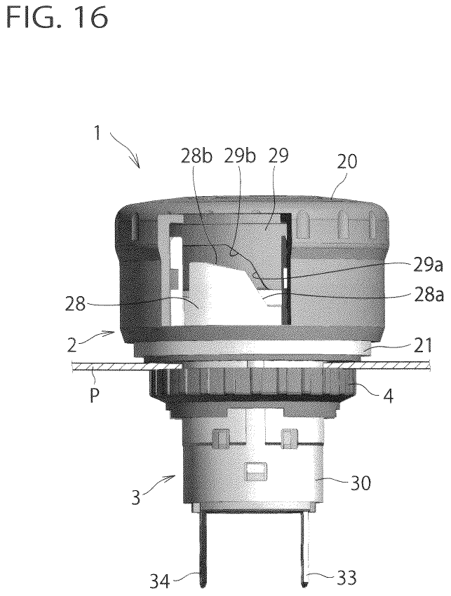

FIGS. 16 to 21 show a push button switch according to a second embodiment of the present invention. In these drawings, the same reference numbers as those in the above-mentioned first embodiment indicate identical or functionally similar elements. In the first embodiment, a so-called “pull-reset type” push button switch in which the return operation is conducted by pulling the push button was explained, but here, a so-called “turn-reset type” push button switch in which the return operation is conducted by turning the push button is taken for example.

As shown in FIG. 16, a push button switch 1, similar to the first embodiment, comprises an operation unit 2 that includes a push button 20 which is push-operatable and return-operatable by an operator and a holding case 21 to hold the push button 20, and a contact unit 3 which is detachably fitted to the operation unit 2 and has a contact housing case 30 which houses contacts (not shown). The push button switch 1 is adapted to be fitted to a panel P of a machine, a control equipment and the like through a lock nut 4 that is screwed into a threaded portion (not shown) of the operation unit 2. In addition, FIG. 16 shows the state (OFF state of the contacts) after the push operation of the push button 20.

Inside the holding case 21, an engagement portion 28 is fixed that has an engagement surface formed of inclined surfaces 28a, 28b that intersect each other. The engagement surface of the engagement portion 28 has a flat V-shaped convex portion formed of these inclined surfaces 28a, 28b. On the other hand, the push button 20 has an engagement portion 29 that has an engagement surface formed of mutually intersecting inclined surfaces 29a, 29b and that is integrated with the push button 20. The engagement portion 29 is adapted to rotate along with the rotation of the push button 20. The engagement surface of the engagement portion 29 has a flat V-shaped concave portion formed of the inclined surfaces 29a, 29b. In addition, the engagement portion 28 is also disposed 180 degrees (or approximately 180 degrees) away along the perimeter of the holding case 21. Likewise, the engagement portion 29 is also disposed 180 degrees (or approximately 180 degrees) away along the perimeter of the push button 20.

During the return operation of the push button 20, the push button 20 is rotatable in the return operational direction, which is the direction from right to left in FIG. 16. Also, inside the push button 20, a return spring (not shown) is provided and it biases the push button 20 at all times in the direction opposite the return operational direction.

Next, the return operation of the push button 20 will be explained in reference to FIGS. 16 to 21.

From the state (OFF state of contacts) after the push operation of the push button 20 shown in FIG. 16, the operator rotates the push button 20 in the return operational direction. Then, as shown in FIG. 17, the inclined surface 29a of the engagement portion 29 moving along with the push button 20 comes into contact and engagement with the inclined surface 28a of the engagement portion 28 on the side of the holding case 21.

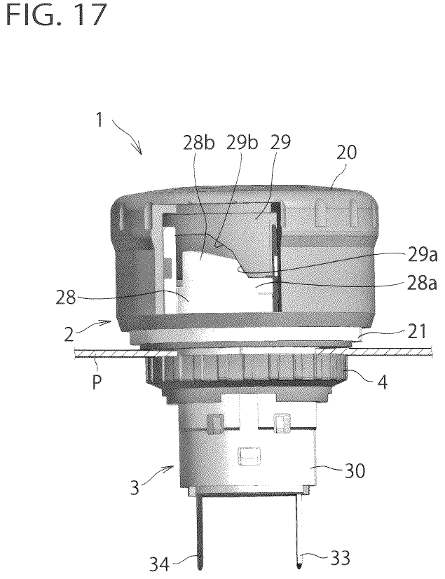

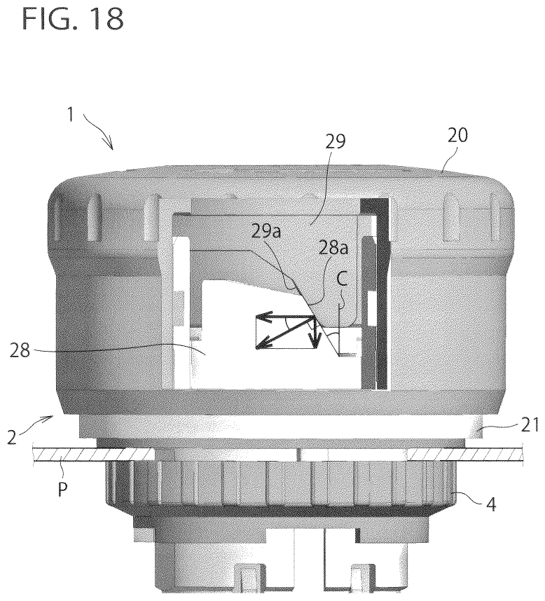

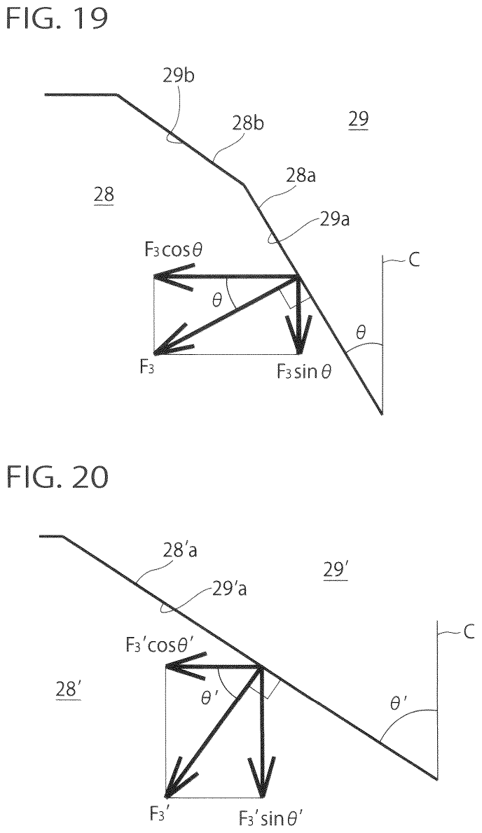

At this juncture, as shown in FIG. 18, a partial enlarged view of FIG. 17, and FIG. 19, an enlarged view of FIG. 18, the pressing load is imparted to the inclined surface 28a of the engagement portion 28 on the side of the holding case 21 from the inclined surface 29a of the engagement portion 29 on the side of the push button 20. When this pressing load is set as F₃, the pressing load F₃ acts onto the inclined surface 28a in the vertical direction.

Now, when the pressing load F₃ is resolved into the return operational direction of the push button 20 (i.e. the left-to-right direction in FIGS. 18 and 19) and a direction perpendicular thereto, a return-operational component force in the return-operational direction and a perpendicular component force in the direction perpendicular to the return-operation direction are designated as follows as can be seen from FIG. 19:

(The return-operational component force)=F₃ cos θ (24)

(The perpendicular component force)=F₃ sin θ (25)

However, θ is defined as an inclined angle on the acute-angle side between the inclined surface 28a of the engagement portion 28 and the axial line C in the axial direction of the shaft portion of the push button 20 (that is, an angle measured in the counterclockwise direction from the axial line C). In this exemplification, θ is set to satisfy, an inequality, θ>45°.

Also, as can be seen from FIG. 19,

$${F}_{3} cos θ > {F}_{3} sin θ \qquad ( 26 )$$

That is,

$$( The return - operational component force ) > ( The perpendicular component force ) \qquad ( 27 )$$

As the engagement portion 29 rotates along with the return operation of the push button 20, the pressing load gradually becomes greater that is applied to the inclined surface 28a of the engagement portion 28 on the side of the holding case 21 from the inclined surface 29a of the engagement portion 29 on the side of the push button 20, and the engagement portion 29 gradually moves upwardly along the inclined surface 28a of the engagement portion 28. Immediately before the engagement state between the inclined surface 29a and the inclined surface 28a becomes disengaged, the return operational component force becomes the largest. That is, at this juncture, the load of the engagement portion 28 relative to the engagement portion 29 is the largest. In this case as well, the above-mentioned relational expression (27) is satisfied.

On the other hand, in a prior-art push button switch of turn-reset type, an engagement state between an engagement portion on the side of a push button 20 and an engagement portion on the side of a holding case 21 is shown in FIG. 20. In the drawing, the same reference numbers as those in FIG. 19 indicate identical or functionally similar elements.

As shown in FIG. 20, a pressing load is applied to the inclined surface 28′a of the engagement portion 28′ on the side of the holding case 21 from the inclined surface 29′a of the engagement portion 29′ on the side of the push button 20. When this pressing load is set as F₃′, the pressing load F₃′ acts onto the inclined surface 28′a in the vertical direction.

Now, when the pressing load F₃′ is resolved into the return operational direction of the push button 20 (i.e. the left-to-right direction in FIG. 20) and the direction perpendicular thereto, a return-operational component force in the return-operational direction and a perpendicular component force in the direction perpendicular to the return-operation direction are designated as follows as can be seen from FIG. 20:

$$( The return - operational component force ) = {F}_{3}^{′} cos {θ}^{′} \qquad ( 28 )$$

$$( The perpendicular component force ) = {F}_{3}^{′} sin {θ}^{′} \qquad ( 29 )$$

However, θ′ is defined as an inclined angle on the acute-angle side between the inclined surface 28′a of the engagement portion 28′ and the axial line C in the axial direction of the shaft portion of the push button 20, that is, θ′ is an angle measured in the counterclockwise direction from the axial line C. In this exemplification, θ′ is set to satisfy, an inequality, θ′>45°.

Also, as can be seen from FIG. 20,

$${F}_{3}^{′} cos {θ}^{′} < {F}_{3}^{′} sin {θ}^{′} \qquad ( 30 )$$

That is,

$$( The return - operational component force ) < ( The perpendicular component force ) \qquad ( 31 )$$

As the engagement portion 29′ rotates along with the return operation of the push button 20, the pressing load gradually becomes greater that is applied to the inclined surface 28′a of the engagement portion 28′ on the side of the holding case 21 from the inclined surface 29′a of the engagement portion 29′ on the side of the push button 20, and the engagement portion 29′ gradually moves upwardly along the inclined surface 28′a of the engagement portion 28′. Immediately before the engagement state between the inclined surface 29′a and the inclined surface 28′a becomes disengaged, the return operational component force becomes the largest. That is, at this time, the load of the engagement portion 28′ relative to the engagement portion 29′ is the largest. In this case as well, the above-mentioned relational expression (31) is satisfied.

Here, even in the event that the pressing load of the same size as that in FIG. 19 is applied to the inclined surface 28′ a of the engagement portion 28′ from the inclined surface 29′a of the engagement portion 29′ (that is, F₃′=F₃ in FIGS. 19, 20), an inequality,

$${F}_{3} cos θ > {F}_{3}^{′} cos {θ}^{′} \qquad ( 32 )$$

is satisfied.

In this manner, at the time of the return operation of the push button 20, when the pressing load is applied to the inclined surface 28a of the engagement portion 28 from the inclined surface 29a of the engagement portion 29, as the pressing load is resolved into the return operational direction and a direction perpendicular thereto, as shown in the above-mentioned inequality (27), the return operational component force in the return operation direction is greater than the perpendicular component force in the direction perpendicular to the return operational direction (see FIG. 19). Also, the return operational component force is greater than a return operational component force in the return operational direction in the prior-art push button switch (see FIGS. 19, 20 and inequality (32)).

Therefore, during the return operation of the push button 20, the return operational component force applied in the return operational direction of the push button 20 is increased and the increased return operational component force is applied to the push button 20 in the return operational direction.

When the return operation of the push button 20 is started, the pressing load gradually becomes greater that acts onto the inclined surface 28a of the engagement portion 28 from the inclined surface 29a of the engagement portion 29 of the shaft portion 22A, such that thereby when the return operation is started the return operational component force in the return operational direction of the push button 20 gradually becomes greater. This return operational component force becomes the largest immediately before the engagement state between the inclined surface 29a of the engagement portion 29 and the inclined surface 28a of the engagement portion 28 becomes disengaged. That is, at this time, the load of the engagement portion 28a relative to the engagement portion 29a becomes the largest. When the engagement state between the inclined surface 29a of the engagement portion 29 and the inclined surface 28a of the engagement portion 28 is disengaged, the push button 20 can quickly move with a large acceleration in the return operational direction. As a result, the respective pairs of contacts can be surely prevented from causing a non-matching of contacts during the return operation.

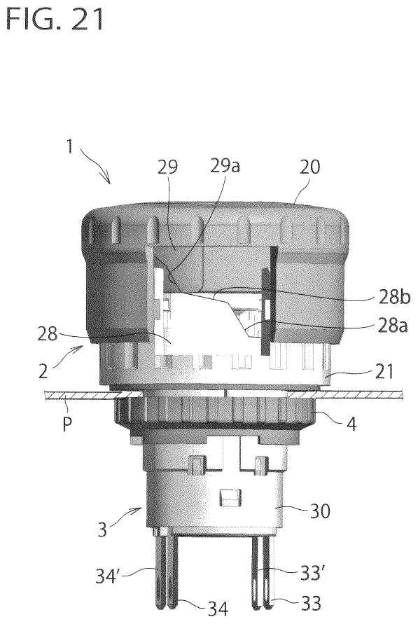

In this manner, according to the second embodiment of the present invention, the inclined surface 28a of the engagement portion 28 functions as a return-speed increasing means that puts a load to the push button 20 and releases the load during the return operation of the push button 20 and that acts to increase the return operational speed in the return operational direction of the push button 20. The inclined angle θ of the inclined surface 28a of the engagement portion 28 is set to fulfill a return-speed increasing function of the push button 20. In addition, by providing such a return-speed increasing means, even in the state that an opening biasing spring (not shown) acts against the return operation during the return operation of the push button 20, the return speed in the return operational direction of the push button 20 can be increased. Thereby, the first and second pairs of contacts can be surely prevented from causing a non-matching of contacts during the return operation. In addition, after the return operation, the inclined surface 29a of the engagement portion 29 moves beyond the apex at which the respective inclined surfaces 28a, 28b of the engagement portion 28 intersect and the inclined surface 29a moves above the inclined surface 28b of the engagement portion 28 (see FIG. 21).

In addition, although it is not shown, the push button switch 1 as shown in FIGS. 16 to 21 may also have a pull-reset function for a return operation shown in the above-mentioned first embodiment. That is, the push button switch 1 is provided with an engagement/disengagement structure formed of a protruding portion on the side of the shaft portion and an engagement member on the side of the holding case 21 as shown in the above-mentioned embodiment and thus the push button switch 1 may be a dual-use one that has both functions of a turn-reset and a pull-reset.

### First Alternative Embodiment

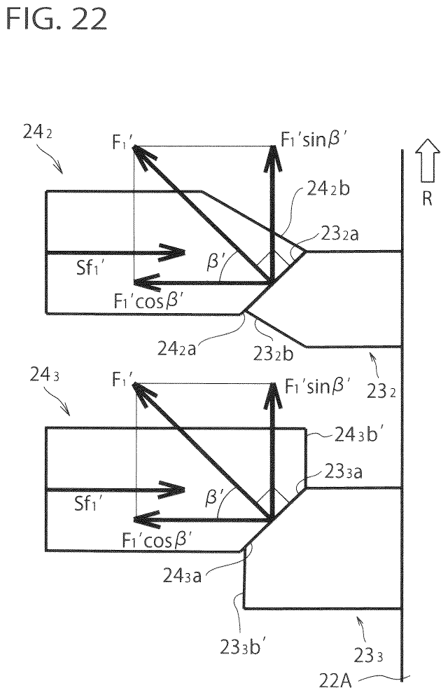

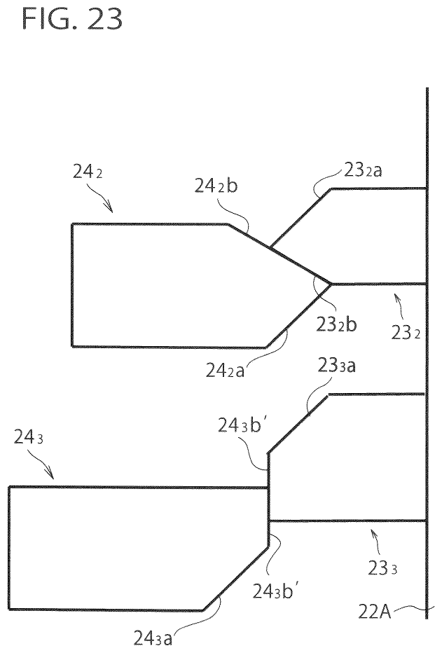

FIGS. 22 and 23 show a push button switch according to a first alternative embodiment of the present invention. FIG. 22 shows the state in the middle of the return operation of the push button and FIG. 23 shows the state after the return operation of the push button. In these drawings, the same reference numbers as those in the above-mentioned first embodiment indicate identical or functionally similar elements.

As shown in FIG. 22, in the push button switch according to the first alternative embodiment, at least two protruding portions (first engagement portion) 23₂, 23₃ are provided at the shaft portion 22A. The respective protruding portions 23₂, 23₃ are arranged at predetermined intervals away from each other in the axial direction of the shaft portion 22A. The protruding portion 23₂ on one side, as with FIG. 14, has a distal end portion formed of mutually intersecting inclined surfaces (engagement surfaces) 23₂a, 23₂b. The protruding portion 23₃ on the other side has a distal end portion that is formed of an inclined surface (engagement surface) 23₃a similar to FIG. 14 and a planar surface 23₃b′ that intersects the inclined surface 23₃a and that extends in the axial line direction of the shaft portion 22A.

Also, on the side of the holding case of the push button, two engagement members (second engagement portion) 24₂, 24₃ that the protruding potions 23₂, 23₃ respectively come into engagement with are arranged at predetermined intervals away from each other in the up-down direction. The engagement member 24₂, as with FIG. 14, have second inclined surfaces (engagement surfaces) 24₂a, 24₂b that respectively engage with the inclined surfaces 23₂a, 23₂b of the protruding portion 23₂. The engagement portion 24₃ includes an inclined surface (engagement surface) 24₃a similar to FIG. 14 and a planar surface 24₂b′ that intersects the inclined surface 24₃a and that extends in the axial direction of the shaft portion 22A.

As shown in FIG. 22, in the middle of the return operation of the push button, in the state that the respective inclined surfaces 23₂a, 23₂a of the protruding portions 23₂, 23₃ on the side of the shaft portion 22A are in engagement with the respective inclined surfaces 24₂a, 24₃a of the protruding portions 24₂, 24₃ on the side of the holding case of the push button, a pressing load F₁′ is respectively applied to the inclined surfaces 24₂a, 24₃a from the inclined surfaces 23₂a, 23₃a. When this pressing load F1′ is resolved into the axial direction of the shaft portion 22A (i.e. the return operational direction of the push button 20) and the direction perpendicular thereto, the return-operational component force in the return operational direction and the perpendicular component force perpendicular to the return operational direction are designated as follows:

(The return-operational component force)=F₁′ sin β′ (33)

(The perpendicular component force)=F₁′ cos β′ (34)

The above-mentioned perpendicular component force acts onto the engagement members 24₂, 24₃ to push them back to the left in FIG. 22 against the elastic repulsive force Sf₁′ of the spring 26₂.

Here, due to β′=45°,

sin β′=cos β′

therefore,

$${F}_{1}^{′} sin {β}^{′} = {F}_{1}^{′} cos {β}^{′} \qquad ( 35 )$$

Hence, according to the equations (33) to (34),

$$( The return - operational component force ) = ( the perpendicular component force ) \qquad ( 36 )$$

As the shaft portion 22A moves in the direction of arrow R along with the return operation of the push button, the pressing load gradually becomes greater that is imparted to the respective inclined surfaces 24₂a, 24₃a of the engagement members 24₂, 24₃ from the respective inclined surfaces 23₂a, 23₃a of the protruding portions 23₂, 23₃ of the shaft portion 22A. Thereby, the return-operational component force in the return operational direction of the push button 20 also gradually becomes greater. This return-operational component force becomes the largest immediately before the engagement state becomes disengaged between the respective inclined surfaces 23₂a, 23₃a of the protruding portions 23₂, 23₃ and the respective inclined surfaces 24₂a, 24₃a of the engagement members 24₂, 24₃. Additionally, in that case as well, the relation in the equation (36) is maintained and thus the return operational component force of the pressing load equals to the perpendicular component force.

That is, in this first alternative embodiment, unlike the first embodiment, the return operational component force of the pressing load is not greater than the perpendicular component force. However, since two protruding portions 23₂, 23₃ are provided at the shaft portion 22A and two engagement members 24₂, 24₃ that respectively engage with the protruding portions 23₂, 23₃ during the return operation of the push button, the load from the engagement members 24₂, 24₃ is increased.

Thereby, immediately after the engagement state between the respective protruding portions 23₂, 23₃ and the respective engagement members 24₂, 24₃ becomes disengaged, the push button 20 can move rapidly with a large acceleration in the return operational direction. As a result, during the return operation, the first and second pairs of contacts can be surely prevented from causing a non-matching of contacts.

After the return operation of the push button 20, the push button 20 moves to the state shown in FIG. 23. At this juncture, the inclined surface 23₂b of the protruding portion 23₂ on the side of the shaft portion 22A is in engagement with the inclined surface 24₂b of the engagement member 24₂ on the side of the holding case of the push button, and the axial planar surface 23₃b′ of the protruding portion 23₃ on the side of the shaft portion 22A is in engagement with the axial planar surface 24₃b′ of the engagement member 24₃ on the side of the holding case of the push button.

### Second Alternative Embodiment

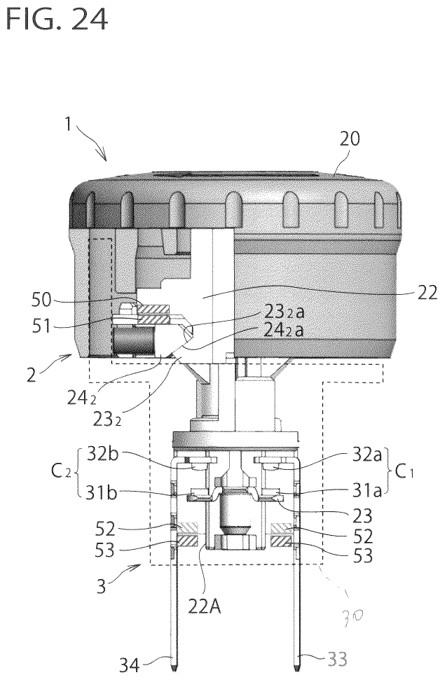

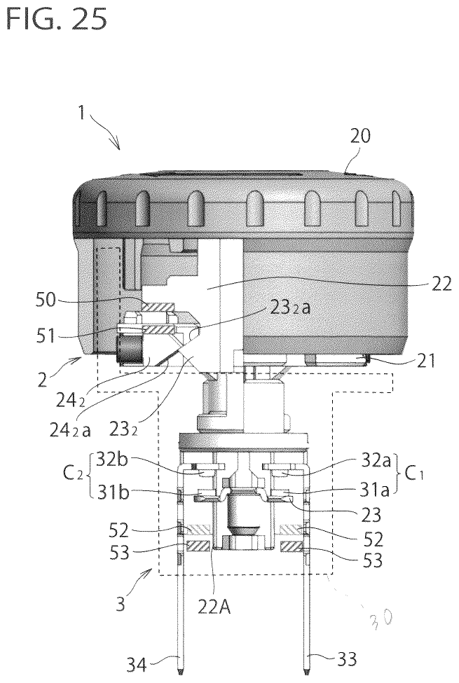

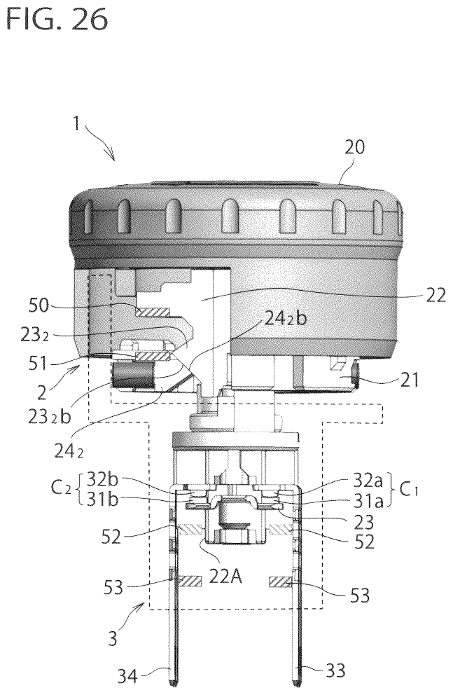

FIGS. 24 to 26 show a push button switch according to a second alternative embodiment of the present invention. FIG. 24 shows the state before the return operation of the push button, FIG. 25 shows the state in the middle of the return operation of the push button, and FIG. 26 shows the state after the return operation of the push button. In these drawings, the same reference numbers as those in the above-mentioned first embodiment indicate identical or functionally similar elements.

As shown in FIGS. 24 to 26, the push button switch 1 according to this second alternative embodiment is provided with magnet sheets (or magnet plates) 50, 51 formed of magnetic material inside the operation unit 2. Likewise, inside the contact unit 3, magnet sheets (or magnet plates) 52, 53 formed of magnetic material are provided.

The magnet sheet 50 is fitted to the inside of the push button 20 and movable along with the push button 20. The magnet sheet 51 is disposed opposite the magnet sheet 50 on the side of the holding case 21. The magnet sheet 52 is fitted to the shaft portion 22A inside the housing case 30 and movable along with the shaft portion 22A. The magnet sheet 53 is disposed opposite the magnet sheet 52 and fitted to the inside of the housing case 30. In this exemplification, the magnet sheets 52, 53 are disposed on opposite sides of the shaft portion 22A.

With regard to polarities of the respective magnet sheets 50, 51, 52 and 53, for example, the magnetic sheets 50 and 51 have the same polarity and likewise, the magnetic sheets 52 and 53 have the same polarity. In this case, a repulsive force acts between the magnetic sheets 50 and 51. Likewise, a repulsive force acts between the magnetic sheets 52 and 53.

Thereby, during the return operation of the push button 20, the push button 20 can be biased toward a pull side, i.e. in the return operational direction, by the magnetic repulsive force (biasing force) applied between the respective magnetic sheets (biasing means). Thus, during the return operation of the push button 20, the return operation can be assisted. As a result, immediately after the engagement state is disengaged between the respective protruding portions 23₂, 23₃ and the respective engagement members 24₂, 24₃, the push button can move quickly with a large acceleration in the return operational direction. As a result, during the return operation, the respective pairs of contacts can be surely prevented from causing a non-matching of contacts.

### Third Alternative Embodiment

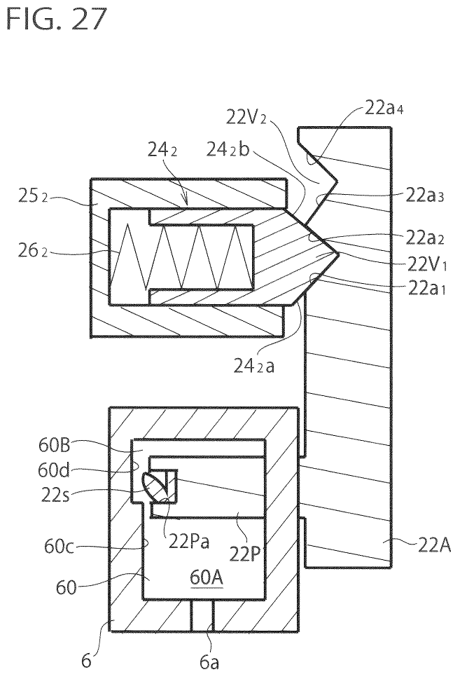

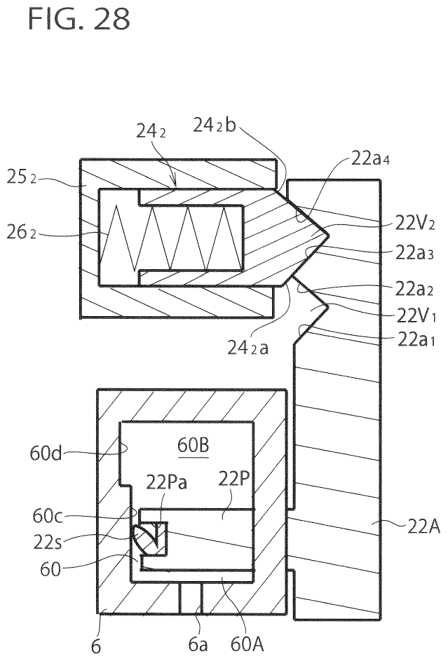

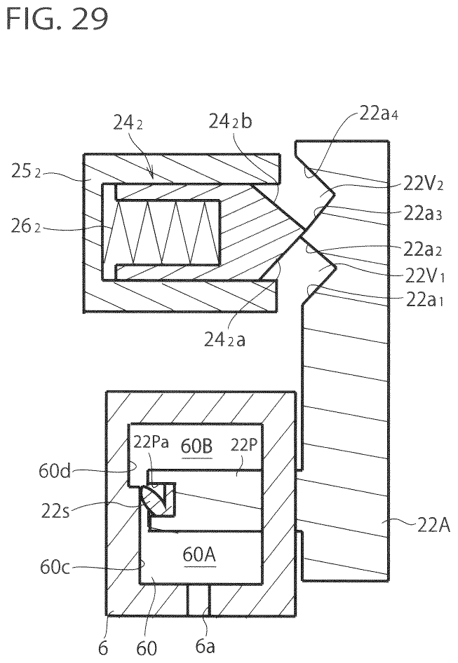

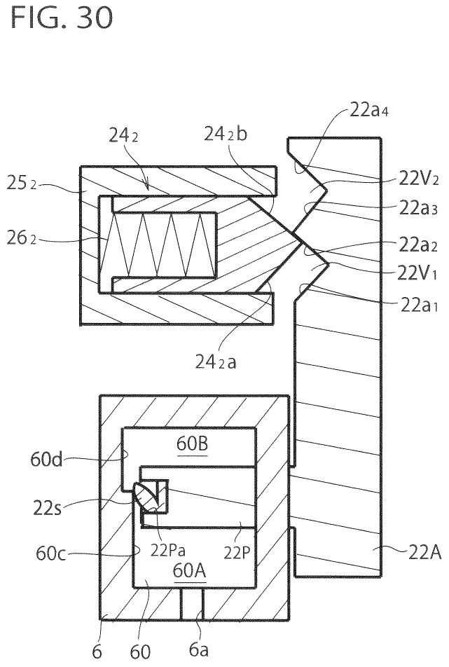

FIGS. 27 to 30 show a push button switch according to a third alternative embodiment of the present invention. FIG. 27 shows the state before the push operation of the push button, FIG. 28 shows the state after the push operation of the push button or the state before the return operation of the push button, and FIGS. 29 and 30 show the state in the middle of the return operation of the push button. In these drawings, the same reference numbers as those in the above-mentioned first embodiment indicate identical or functionally similar elements.

As shown in FIGS. 27 to 30, the push button switch 1 according to this third alternative embodiment includes a chamber 6 disposed lateral to the lower portion of the shaft portion 22A. The chamber 6 has a compartment 60 therein surrounded by a partition wall. A portion of the partition wall is formed with a through hole 6a that provides a communication of the compartment 60 with the outside.

At the lower part of the shaft portion 22A, an extension portion (partition member) 22P is integrated with the lower part, which extends laterally toward the compartment 60 of the chamber 6. The extension portion 22P is adapted to move integrally with shaft portion 22A. The extension portion 22P enters the compartment 60 through a vertically elongated aperture (not shown) that penetrates the partition wall of the chamber 6. A seal member (not shown) seals between the extension portion 22P and the vertically elongated aperture that the extension portion 22P passes through. A seal member 22s is attached to a concavity 22Pa formed at a distal end of the extension portion 22P. Inside the compartment 60, a concaved portion 60d is formed at a part of the inner wall surface 60c of the partition wall that faces the distal end of the extension portion 22P.

The seal member 22s is adapted to take a partitioning position at which a distal end of the seal member 22s contacts the inner wall surface 60c as shown in FIGS. 28 and 29 to seal it and the compartment 60 is thus divided into a lower-side compartment 60A below the extension portion 22P and an upper-side compartment 60B above the extension portion 22P, and to take a communication position at which the distal end of the seal member 22s faces the concaved portion 60d to form a gap relative to the concave portion 60d as shown in FIGS. 27 and 30 and the upper-side compartment 60B and the lower-side compartment 60A are communicated with each other.

At the upper part of the shaft portion 22A, flat V-shaped engagement grooves 22V₁, 22V₂ are formed. The engagement groove 22V₁ is disposed on the lower side and formed of two inclined surfaces 22a₁, 22a₂. The engagement groove 22V₂ (first engagement groove) is disposed on the upper side and formed of two inclined surfaces 22a₃, 22a₄. As these inclined surfaces, it is not restricted to a combination of the inclined angles shown in FIG. 10 or FIG. 13 of the above-mentioned first embodiment, but any other appropriate combination of inclined angles can be employed. Also, a distal end portion of the engagement member (second engagement portion) 24₂ provided on the side of the holding case of the push button is adapted to detachably engage with the respective engagement grooves 22V₁, 22V₂.

Next, the operation of the above-structured push button switch will be explained.

In the state before the push operation of the push button, as shown in FIG. 27, the upper-side inclined surface 24₂b of the engagement member 24₂ is in engagement with the inclined surface 22a₂ of the engagement groove 22V₁ and the lower-side inclined surface 24₂a of the engagement member 24₂ is in engagement with the inclined surface 22a₁ of the engagement groove 22V₁. Also, at this juncture, the seal member 22s at the distal end of the extension portion 22P of the shaft portion 22A is positioned against the concaved portion 60d.

From this state, when the operator presses the push button, as shown in FIG. 28, the shaft portion 22A moves downwardly along with the push button and accordingly the extension portion 22P also moves downwardly. During that time, the seal member 22s at the distal end of the extension portion 22P moves downwardly contacting the inner wall surface 60c. At this juncture, compressed air in the lower compartment 60A is released outside through the through hole 6a. Thereby, a downward movement of the shaft portion 22A is conducted in a smooth manner. Also, due to the downward movement of the shaft portion 22A, the distal end portion of the engagement member 24₂ climbs over the engagement groove 22V₁ and moves to the engagement state with the engagement groove 22V₂.

From the state after the push operation shown in FIG. 28, the operator pulls the push button to perform a return operation. At this juncture, as shown in FIG. 29, as the shaft portion 22A moves upwardly, the extension portion 22P gradually moves upwardly with the distal end of the seal member 22s of the extension portion 22P contacted with the inner wall surface 60c of the partition wall. During that time, as the upper-side compartment 60B in the compartment 60 is gradually compressed to increase the internal pressure of the upper-side compartment 60B, thus increasing the load to the push button in the return operational direction (upper direction in FIG. 29). Immediately before the distal end of the seal member 22s is about to move to the position located opposite the concaved portion 60d (at this time, immediately before the lower-side inclined surface 24₂a of the engagement member 24₂ is about to climb over the inclined surface 22a of the engagement groove 22V₂) from the state in which the distal end of the seal member 22s is in contact with the inner wall surface 60c of the partition wall, the load to the push button becomes the largest.

From the state shown in FIG. 29, when the operator further pulls the push button, as shown in FIG. 30, the distal end of the seal member 22s moves to the position located opposite the concaved portion 60d from the state in which the distal end of the seal member 22s is in contact with the inner wall surface 60c of the partition wall. At this juncture, a gap is formed between the distal end of the seal member 22s and the concaved portion 60d, such that thereby air moves into the lower-side compartment 60A through the gap between the distal end of the seal member 22s and the concaved portion 60d from the upper-side compartment 60B where the internal pressure is increased. Thus, since the internal pressure of the upper-side compartment 60B decreases rapidly, the load to the push button rapidly decreases. As a result, the lower-side inclined surface 24₂a of the engagement member 24₂ climbs over the inclined surface 22a₃ of the engagement groove 22V₂ and thus the push button can quickly move with a large acceleration in the return operational direction. In such a manner, the respective pairs of contacts can be surely prevented from causing a non-matching of contacts during the return operation.

In this third alternative embodiment, the engagement groove 22V₂, the engagement member 24₂ and the extension portion 22P function as a return-speed increasing means of the present invention.

### Fourth Alternative Embodiment

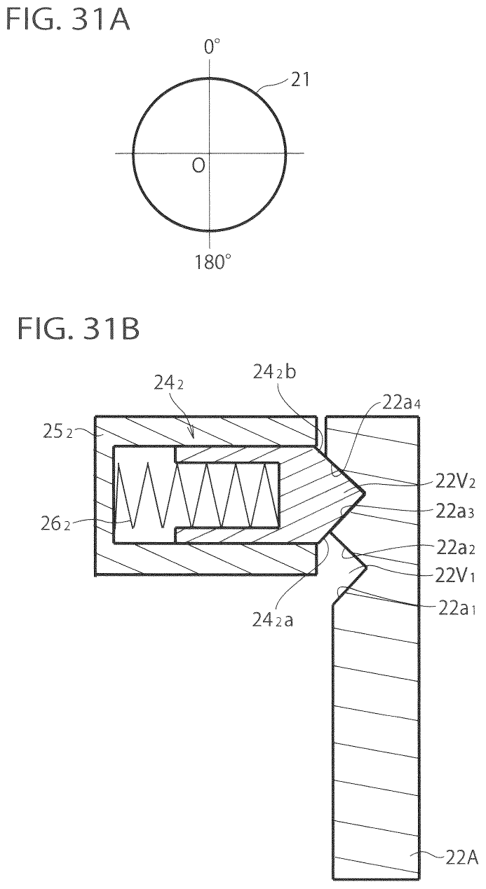

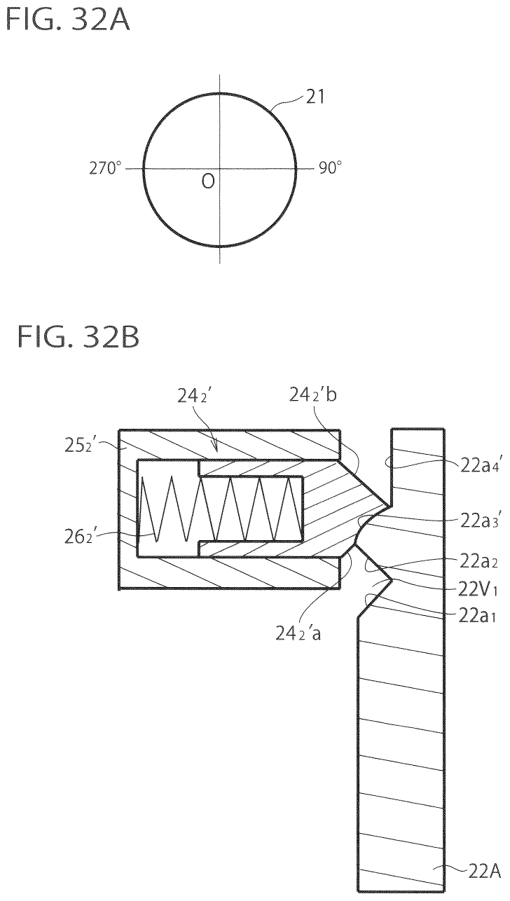

FIGS. 31 and 32 show a push button switch according to a fourth alternative embodiment of the present invention. The respective drawings show the state before the return operation of the push button. In these drawings, the same reference numbers as those in the above-mentioned respective embodiments and alternative embodiments indicate identical or functionally similar elements.

In FIGS. 31 and 32, the respective drawing B is a partially enlarged longitudinal sectional view of the push button switch and shows an engagement member on the side of the holding case, and the respective drawing A shows the position in which the engagement member in drawing B is disposed. As shown in FIG. 31A, the engagement member 24₂ of FIG. 31B is respectively disposed at the position of 0° and the position of 180° located opposite the position of 0° in a circumferential direction around the center O of the holding case 21. Also, as shown in FIG. 32A, the engagement member 24₂′ of FIG. 32B is respectively disposed at the position of 90° and the position of 270° located opposite the position of 90° in the circumferential direction around the center O of the holding case 21.

As shown in FIG. 31B, the shaft portion 22A on the side of the push button is formed with two engagement grooves 22V₁, 22V₂. The engagement groove 22V₁ is formed of a pair of mutually intersecting inclined surfaces 22a₁, 22a₂ and the engagement groove 22V₂ disposed above the engagement groove 22V₁ is formed of a pair of mutually intersecting inclined surfaces 22a₃, 22a₄. In the state prior to the return operation shown in FIG. 31B, a distal end portion formed of a pair of mutually intersecting inclined surfaces 24₂a, 24₂b in the engagement member 24₂ on the side of the holding case 21 is in engagement with the engagement groove 22V₂ of the shaft portion 22A.

As shown in FIG. 32B, the shaft portion 22A on the side of the push button is formed with one engagement groove 22V₁, an inclined surface 22a₃′ formed by a curved face, and an axially extending planar surface 22a₄′ connected to the inclined surface 22a₃′. In the state prior to the return operation shown in FIG. 32B, an inclined surface 24₂′ a constituting the distal end portion of the engagement member 24₂′ on the side of the holding case 21 is in engagement with the inclined surface 22a₃′ of the shaft portion 22A.

At the time of the return operation of the push button, the operator pulls up the shaft portion 22A along with the push button in the upward direction of FIG. 31B. Then, as shown in FIG. 31B, from the state in which the distal end portion of the respective engagement members 24₂, which is oppositely disposed at the positions of 0° and 180° in the circumferential direction of the holding case 21, is engaged with the engagement groove 22V₂ of the shaft portion 22A, the distal end portion of the engagement members 24₂ climbs over the inclined surface 22a₃ and comes into engagement with the lower-side engagement groove 22V₁. On the other hand, as shown in FIG. 32B, the distal end portion of the respective engagement members 24₂′ oppositely disposed at the positions of 90° and 270° in the circumferential direction of the holding case 21, from the state in which the distal end portion is engaged with the inclined surface 22a₃′ formed of the curved surface of the shaft portion 22A, slides along the curved surface thus gradually compressed and climbs over the inclined surface 22a₃′ and comes into engagement with the lower-side engagement groove 22V₁.

In such a manner, in this fourth alternative embodiment, during the return operation of the push button, in addition to the load by the respective engagement members 24₂, the load by the respective engagement members 24₂′ is also applied, thus increasing the load on the push button. Immediately before the inclined surfaces 24₂a, 24₂′a of the respective engagement members 24₂, 24₂′ climb over the corresponding inclined surface 22a₃, the maximum load is applied to the push button and thus the maximum return operational component force is applied in the return operation direction of the push button.

Therefore, immediately after the inclined surfaces 24₂a, 24₂′a climb over the corresponding inclined surface 22a₃, the maximum return operational component force causes the push button to move rapidly with a large acceleration in the return operational direction. As a result, the respective pairs of contacts can be surely prevented from causing a non-matching of contacts during the return operation.

### Fifth Alternative Embodiment

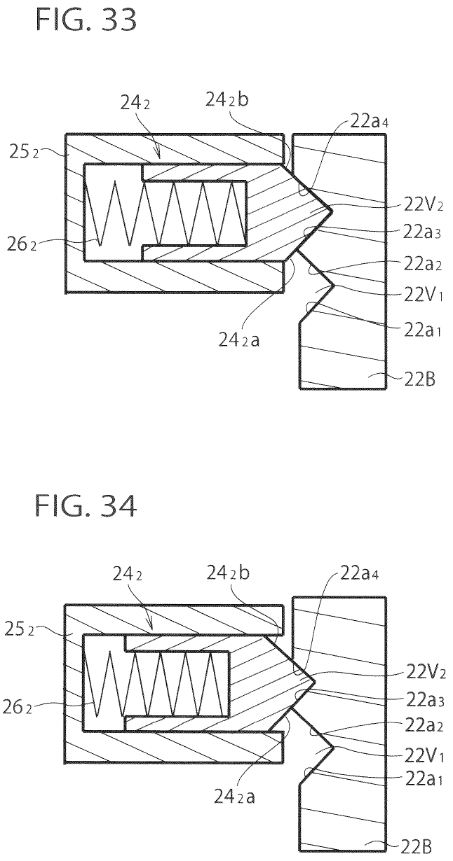

FIGS. 33 to 36 show a push button switch according to a fifth alternative embodiment of the present invention. A push button switch of a turn-reset type is shown. The respective drawings show a change in the engagement state between the engagement member and the engagement groove engaged by the engagement member in time-series manner when the push button is rotated during the return operation. In these drawings, the same reference numbers as those in the above-mentioned respective embodiments and alternative embodiments indicate identical or functionally similar elements.

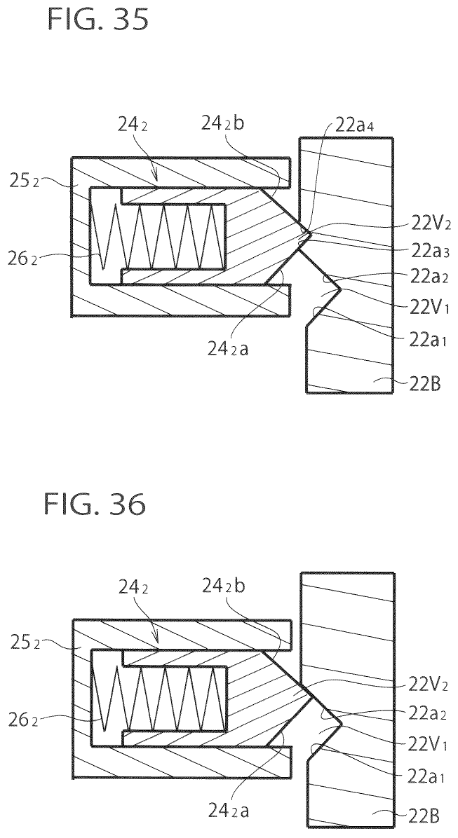

FIG. 33 shows the state prior to the return operation, i.e. the rotational angle of the push button during the return operation is 0°, FIG. 34 shows the state in which the rotational angle of the push button during the return operation is 90°, FIG. 35 shows the state in which the rotational angle of the push button during the return operation is 180°, and FIG. 36 shows the state in which the rotational angle of the push button during the return operation is over 180°.

As shown in the respective drawings, a boss portion 22B of the push button includes a flat V-shaped first and second engagement grooves 22V₁, 22V₂ that are disposed adjacent to each other in the axial direction. The engagement groove 22V₁ is formed of mutually intersecting inclined surfaces 22a₁, 22a₂ and similarly the engagement groove V₂ disposed above the engagement groove V₁ is formed of mutually intersecting inclined surfaces 22a₃, 22a₄. The engagement member 24₂ provided on the side of the holding case of the push button includes a flat V-shaped distal end portion, which is formed of mutually intersecting inclined surfaces 24₂a, 24₂b. The distal end portion of the engagement member 24₂ is engageable with the respective engagement grooves V₁, V₂.

The first engagement groove 22V₁ of the boss portion 22B has a predetermined depth, which is not varied in the circumferential direction. However, the depth of the second engagement groove 22V₂ is varied in the circumferential direction. The second engagement groove 22V₂ has the maximum depth at the rotational angle of 0° of the push button during the return operation as shown in FIG. 33, and the depth of the second engagement groove 22V₂ gradually decreases as the rotational angle of the push button during the return operation increases from 0° through 90° to 180° as shown in FIGS. 34, 35 and 36. When the rotational angle of the push button during the return operation exceeds 180°, as shown in FIG. 36, the depth of the second engagement groove 22V₂ becomes zero.

During the return operation, when the operator rotates the push button in the return operational direction, the boss portion 22B rotates along with the push button. Along with the rotation of the boss portion 22B, as shown in FIGS. 33, 34 and 35, the depth of the engagement groove 22V₂, which is engaged with the distal end portion of the engagement member 24₂, on the side of the boss portion 22B becomes gradually shallower. Along with that, the engagement member 24₂ withdraws into the guide portion 25₂ and thus the load on the push button during the return operation increases. When the depth of the engagement groove 22V₂ that the engagement member 24₂ engages with becomes zero, the load becomes the largest and thus the maximum return operational component force is applied in the return operational direction of the push button.

Therefore, immediately before the distal end portion of the engagement member 24₂ enters the first engagement groove V₁ as shown in FIG. 36, by the maximum return operational component force, the push button can move rapidly with a large acceleration in the return operational direction. Thereby, the respective pairs of contacts can be surely prevented from causing a non-matching of contacts during the return operation

### Sixth Alternative Embodiment

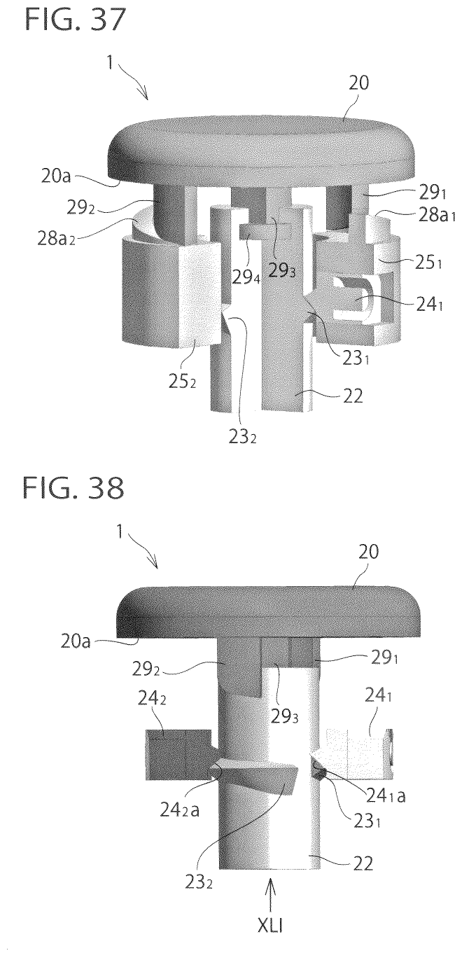

FIGS. 37 to 49 show a push button switch according to a sixth alternative embodiment of the present invention. A push button switch of a turn-reset type as the mode of the return operation is shown. FIG. 37 is a partial perspective view with a portion cut away of the push button switch, showing the state after the push operation, that is, the state before the return operation of the push button. FIGS. 38 to 41 are partial views for explaining the details of the respective portions of the push button switch. FIGS. 42 to 44 show the operation of the respective portions in time-series manner when turn-resetting the push button. FIGS. 45 to 48 show a change in the engagement state between a protruding portion of the shaft portion and an engagement portion in time-series manner when turn-resetting the push button. FIG. 49 shows a change in the inclined angle of the upper-side inclined surface of the protruding portion at the time of engagement with the engagement member. FIG. 49 is a view for explaining a change of the inclined angles of the upper-side inclined surface of the protruding portion at the time of the engagement with the engagement member. In these drawings, the same reference numbers as those in the above-mentioned respective embodiments and alternative embodiments indicate identical or functionally similar elements.

As shown in FIG. 37, at a central portion of a backside surface 20a of the push button 20, a boss portion 29₃ of a small diameter is provided integrally with the push button 20. At a distal end of the boss portion 29₃, a flange portion 29₄ of a large diameter is provided. The boss portion 29₃ and the flange portion 29₄ are engaged with a concave portion formed at the distal end of the shaft portion 22 extending in the axial direction (in the up-down direction in FIG. 37). Thereby, during the return operation by the rotation of the push button 20, the shaft portion 22 is adapted to rotate along with the push button 20.

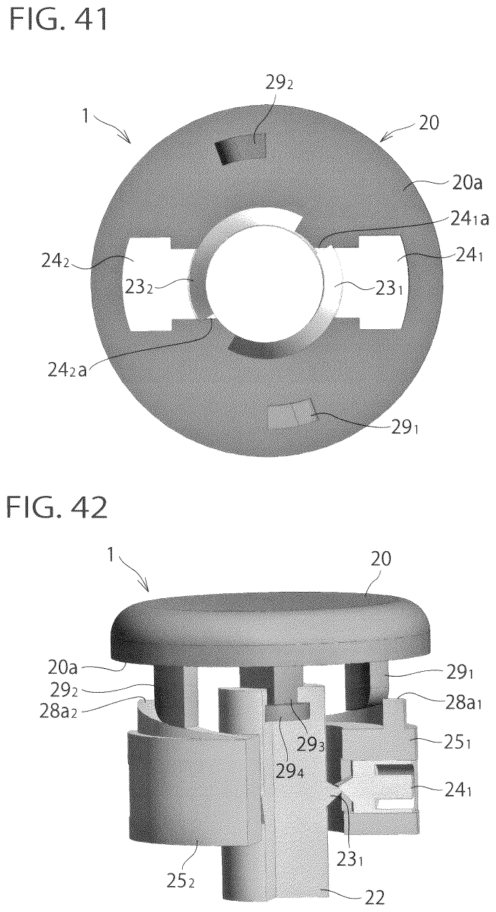

On an outer circumferential side of a backside surface 20a of the push button 20, a pair of protrusions 29₁, 29₂ that protrude axially downwardly are provided integrally with the push button 20. On the other hand, to the outer side of the shaft portion 22, a pair of engagement members 24₂, 24₂ are provided (see FIGS. 38 and 41) and the respective engagement members 24₁, 24₂ are disposed opposite each other across the shaft portion 22. Also, the respective engagement members 24₁, 24₂ are housed slidably in the respective guide portions 25₁, 25₂ disposed circumferentially around the shaft portion 22 and are biased toward the shaft portion 22 at all times by an elastic repulsive force of a spring (described later).

On the outer circumference of the shaft portion 22, as shown in FIGS. 38 to 41, a pair of ridge portions (protruding portions) 23₁, 23₂ protruding outwardly and extending circumferentially are provided integrally with the shaft portion 22. The respective ridge portions 23₁, 23₂ are disposed oppositely to each other across the shaft portion 22 and spaced away from each other at a circumferential interval.

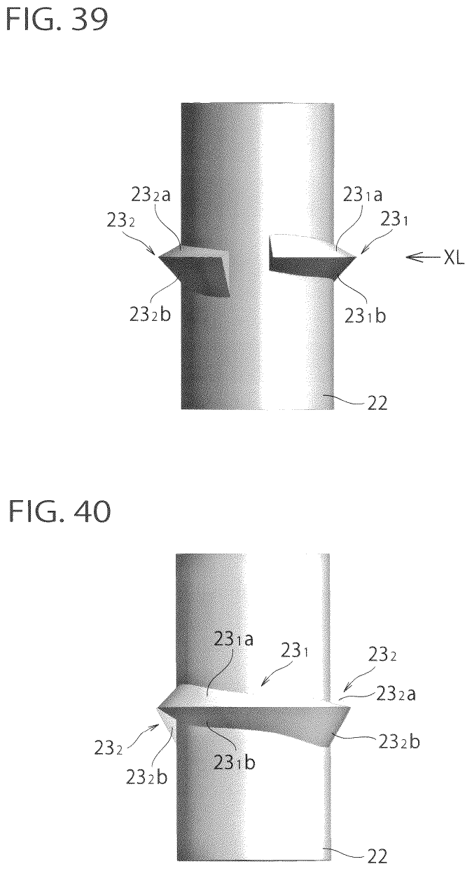

As shown in FIGS. 39 and 40, the ridge portion 23₁ is formed of mutually intersecting upper-side inclined surface 23₁a and lower-side inclined surface 23₁b and has a longitudinal section of a generally triangular shape. The upper-side inclined surface 23₁a has an inclined angle (inclination) that gradually changes from the start-end side (left side in FIG. 40) toward the terminal-end side (right side in FIG. 40).

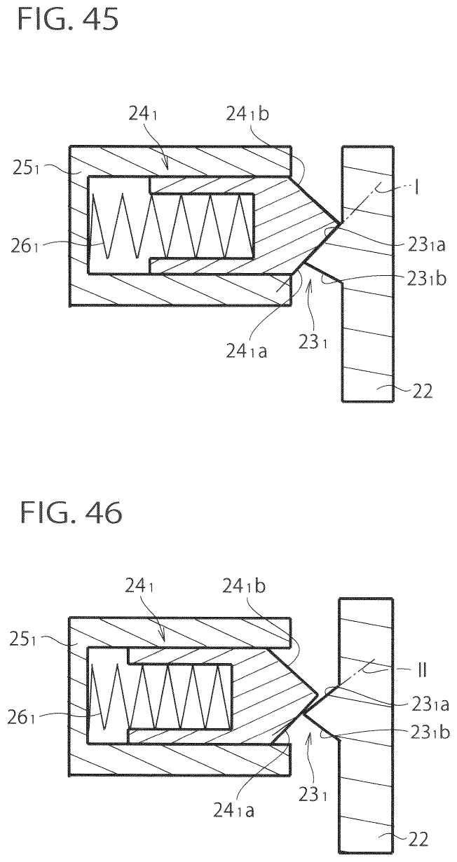

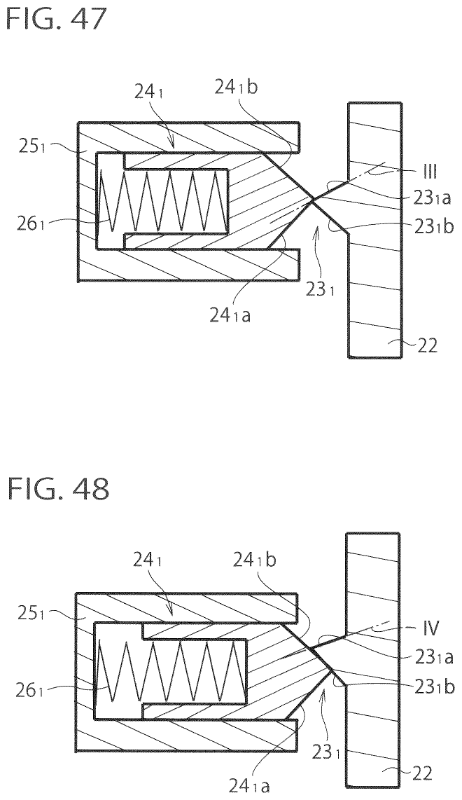

A change of inclination of the upper-side inclined surface 23₁a will be explained in reference to FIGS. 45 to 48. In the respective drawings, dash-and-dot lines I, II, III and IV respectively show inclinations of the upper-side inclined surface 23₁a. The inclination of the upper-side inclined surface 23₁a is the gentlest at the start side relative to the axial direction (up-down direction of FIG. 45) of the shaft portion 22 as shown in the dash-and-dot line I in FIG. 45. At an intermediate stage from the start-end side toward the terminal-end side, as shown in dash-and-dot lines II and III in FIGS. 46 and 47, the inclination of the upper-side inclined surface 23₁a is gradually steep relative to the axial direction (up-down direction of FIGS. 46, 47) of the shaft portion 22. On the terminal-end side, as shown in the dash-and-dot line IV in FIG. 48, the inclination of the upper-side inclined surface 23₁a becomes the steepest relative to the axial direction (up-down direction of FIG. 48) of the shaft portion 22.

The lower-side inclined surface 23₁b also has an inclined angle (inclination) that gradually changes from the start-end side (left side in FIG. 40) toward the terminal-end side (right side in FIG. 40). With regard to a change of inclination of the lower-side inclined surface 23₁b, as can be seen from FIGS. 45 to 49, contrary to the change of inclination of the upper-side inclined surface 23₁a, it is the steepest on the start-end side, gradually gentle toward the termina-end side from the start-end side, and the gentlest on the terminal-end side.

On the other hand, as shown in FIGS. 39 and 40, the ridge portion 23₂ is formed of mutually intersecting upper-side inclined surface 23₂a and lower-side inclined surface 23₂b similar to the ridge portion 23₁ and has a longitudinal section of a generally triangular shape. The upper-side inclined surface 23₂a and the lower-side inclined surface 23₂b have an inclined angle (inclination) that gradually changes from the start-end side (right side into the page of FIG. 40) toward the terminal-end side (left side into the page of FIG. 40), and the way of change in inclination is similar to the ridge portion 23₁.

As shown in FIGS. 37 and 42 to 44, the respective guide portions 25₁, 25₂ have engagement portions 28a₁, 28a₂ extending circumferentially along the upper surface thereof and integrated therewith. The upper surface of the respective engagement portions 28a₁, 28a₂ is an inclined surface whose height is gradually greater along the circumferential direction. In the state prior to the return operation shown in FIG. 37, the bottom surface of the respective protrusions 29₁, 29₂ of the push button 20 is in contact with the top surface of the respective engagement portions 28a₁, 28a₂. Also, the upper-side inclined surfaces 23₁a, 23₂a of the respective ridge portions 23₁, 23₂ of the shaft portion 22 is in contact and engagement with the lower-side inclined surface of the respective engagement members 24₁, 24₂ (see FIG. 45).

Next, the return operation of the push button 20 will be explained in reference to FIGS. 37 and 42 to 49.

At the time of the return operation of the push button 20, from the state shown in FIG. 37, the operator rotates the push button 20 in the circumferential direction or the return operational direction (in the exemplification, in a clockwise direction as viewed from a front-surface side of the push button 20). Due to the rotation of the push button 20, the shaft portion 22 rotates along with the push button 20.

Now, from the state shown in FIG. 37, when the push button 20 rotates generally 30° in the circumferential direction, the state is transferred to a state shown in FIG. 42. At this juncture, the respective protrusions 29₁, 29₂ on the backside surface 20a of the push button 20 moves approximately 30° in the circumferential direction toward the side that the height of the inclined surface becomes higher with the bottom surface of the respective protrusions 29₁, 29₂ contacted with the inclined surface of the top surface of the engagement portions 28a₁, 28a₂. Also, the push button 20 moves upwardly along with the shaft portion 22 according to an increase in height of the inclined surface. At this juncture, the upper-side inclined surfaces 23₁a, 23₂a of the respective ridge portions 23₁, 23₂ of the shaft portion 22 that rotates along with the push button 20 are in contact with the lower-side inclined surfaces 24₁a, 24₂a (see FIGS. 41, 45) of the engagement member 24₂, 24₂ and move along the lower-side inclined surfaces 24₁a, 24₂a toward the side of the distal end thereof (see FIG. 46).

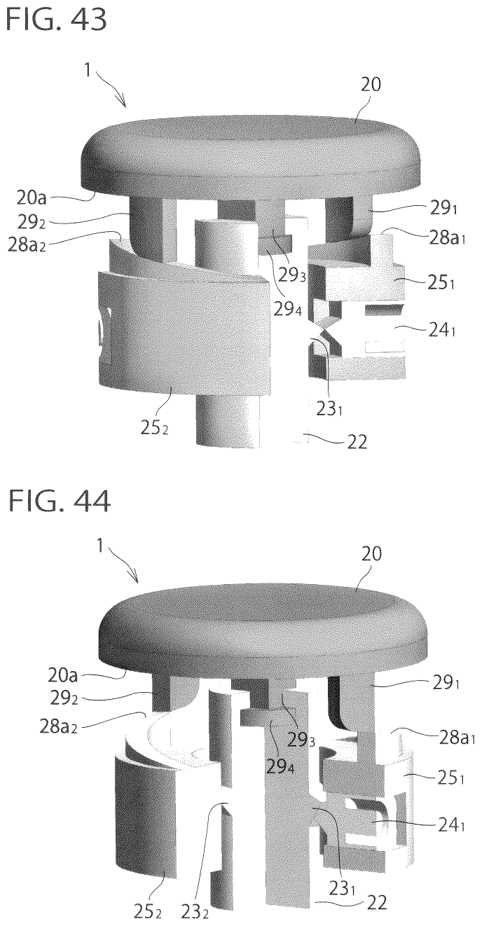

When the push button 20 rotates approximately 15 degrees in the circumferential direction from the state shown in FIG. 42 (that is, rotates approximately 45 degrees in total from the state shown in FIG. 37), the state is transferred to a state shown in FIG. 43. At this juncture, the respective protrusions 29₁, 29₂ on the backside surface 20a of the push button 20 are in contact with the inclined surface of the respective engagement portions 28a₁, 28a₂ and move approximately further 15 degrees in the circumferential direction toward the side that the height of the inclined surface becomes higher. Also, according to a further increase in height of the inclined surface, the push button 20 moves further upwardly along with the shaft portion 22. The upper-side inclined surfaces 23₁a, 23₂a of the respective ridge portions 23₁, 23₂ of the shaft portion 22 that rotates along with the push button 20 are in contact with the lower-side inclined surfaces 24₁a, 24₂a (see FIGS. 41, 45) of the respective engagement members 24₁, 24₂ and further move along the lower-side inclined surfaces 24₁a, 24₂a toward the distal end thereof and is located at a position near the distal end (see FIG. 47). At this time, the load of the respective engagement members 24₁, 24₂ on the push button 20 is the largest and the maximum return operational component force is applied in the return operational direction of the push button 20.

When the push button 20 rotates approximately 45 degrees in the circumferential direction from the state shown in FIG. 43 (that is, rotates approximately 90 degrees in total from the state shown in FIG. 37), in the middle of the rotation, the engagement state between the upper-side inclined surfaces 23₁a, 23₂a of the respective ridge portions 23₁, 23₂ and the lower-side inclined surfaces 24₁a, 24₂a of the respective engagement members 24₁, 24₂ becomes disengaged. Immediately after this disengagement, due to the maximum return operational component force that has been applied to the push button 20, the push button 20 can move rapidly with a large acceleration in the return operational direction. Thereby, the respective pairs of contacts of the push button 1 (see FIGS. 3, 4) can be surely prevented from causing a non-matching of contacts during the return operation. In addition, when the push button 20 rotates approximately 45 degrees in the circumferential direction from the state shown in FIG. 43, the state is transferred to a state shown in FIG. 44 and the return operation of the push button 20 is completed.

Here, a change of inclined angles of the upper-side inclined surfaces 23₁a, 23₂a of the respective ridge portions 23₂, 23₂ that engage with the lower-side inclined surfaces 24₁a, 24₂a of the respective engagement members 24₁, 24₂ during the return operation and a change in engagement states will be explained using FIG. 49 in reference to FIGS. 45 to 48 (further, FIGS. 37, 42 to 44). In this exemplification, the engagement state between the engagement member 24₁ and the ridge portion 23₁ is taken for example, but this is also true for the engagement member 24₂.

A dash-and-dot line I in FIG. 49 corresponds to the engagement state between the engagement member 24₁ and the ridge portion 23₁ in FIG. 45 and show an inclination of the upper-side inclined surface 23-a of the ridge portion 23₁ in the state prior to the return operation of the push button 20. At this juncture, the upper-side inclined surface 23₁a of the ridge portion 23₁ is in surface contact with the lower-side inclined surface 24₁a of the engagement member 24₁ along the approximately entire surface of the inclined surface (see FIG. 37).

A dash-and-dot line II in FIG. 49 corresponds to the engagement state between the engagement member 24₁ and the ridge portion 23₁ in FIG. 46 and shows an inclination of the upper-side inclined surface 23₁a of the ridge portion 23₁ in the state that the push button 20 is rotated by approximately 30 degrees in the circumferential direction. At this juncture, a portion of the distal end side of the upper-side inclined surface 23₁a of the ridge portion 23₁ is in contact with the lower-side inclined surface 24₁a of the engagement member 24₁ (see FIG. 42).

A dash-and-dot line III in FIG. 49 corresponds to the engagement state between the engagement member 24₁ and the ridge portion 23₁ in FIG. 47 and shows an inclination of the upper-side inclined surface 23₁a of the ridge portion 23₁ in the state that the push button 20 is rotated by approximately 45 degrees in total in the circumferential direction. At this juncture, a distal end of the upper-side inclined surface 23₁a of the ridge portion 23₁ is in contact with the lower-side inclined surface 24-a of the engagement member 24₁ (see FIG. 43).

A dash-and-dot line IV in FIG. 49 corresponds to the engagement state of the engagement member 24₁ and the ridge portion 23₁ in FIG. 48 and shows an inclination of the upper-side inclined surface 23₁a of the ridge portion 23₁ in the state that the push button 20 is rotated by approximately 90 degrees in total in the circumferential direction. At this juncture, the upper-side inclined surface 23₁a of the ridge portion 23₁ climbs over the lower-side inclined surface 24₁a of the engagement member 24₁ and comes into engagement with the upper-side inclined surface 24₁b (see FIG. 44).

In such a manner, in the state shown in FIGS. 43 and 47 that the push button 20 is rotated approximately by 45 degrees in total in the circumferential direction, the distal end of the upper-side inclined surface 23₁a of the ridge portion 23₁ whose inclination becomes steeper is in contact with the lower-side inclined surface 24₁a of the engagement member 24₁ and the engagement state between the upper-side inclined surface 23₁a of the ridge portion 23₁ and the lower-side inclined surface 24₁a of the engagement member 24₁ is hard to be disengaged. Thereby, immediately after the engagement state between the upper-side inclined surface 23-a and the lower-side inclined surface 24₁a becomes disengaged, the maximum return operational component force is applied to the push button 20.

### Seventh Alternative Embodiment

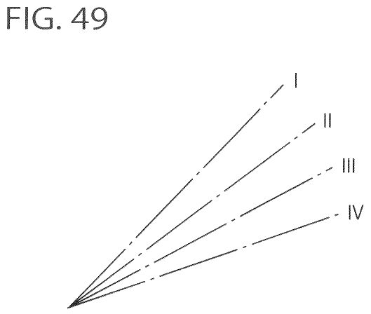

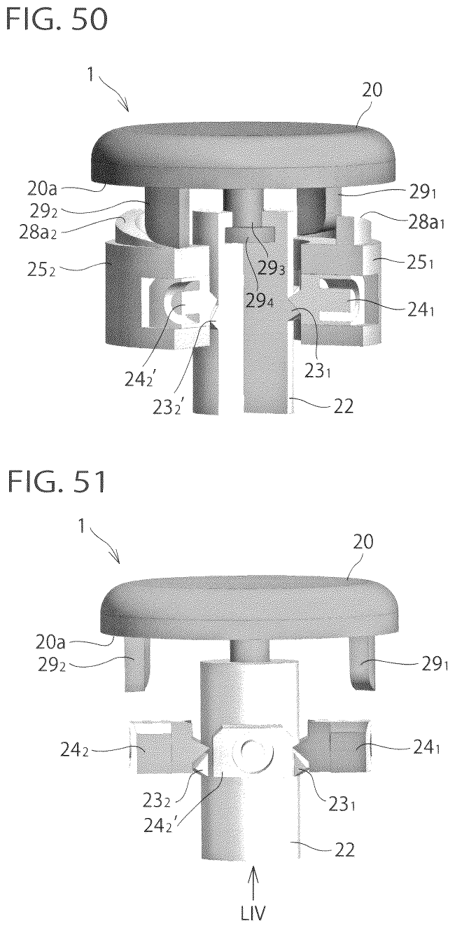

FIGS. 50 to 58 show a push button switch according to a seventh alternative embodiment of the present invention. A push button switch of a pull-reset type as the mode of the return operation is shown. FIG. 50 is a partial perspective view with a portion cut away of the push button switch, showing the state after the push operation of the push button, that is, the state before the return operation of the push button. FIGS. 51 to 54 are partial views for explaining the details of the respective portions of the push button switch. FIGS. 55 to 58 show the operation of the respective portions in time-series manner when pull-resetting the push button. In these drawings, the same reference numbers as those in the above-mentioned respective embodiments and alternative embodiments (specially, the above-mentioned sixth alternative embodiment) indicate identical or functionally similar elements.

As shown in FIG. 50, the push button 20 is fixed to the distal end of the shaft portion 22 through a boss portion 29₃ at the center of the backside surface 20a of the push button 20 and a flange portion 29₄ at the distal end of the boss portion 29₃. During the return operation due to a pull of the push button 20, the shaft portion 22 moves axially upwardly along with the push button 20.

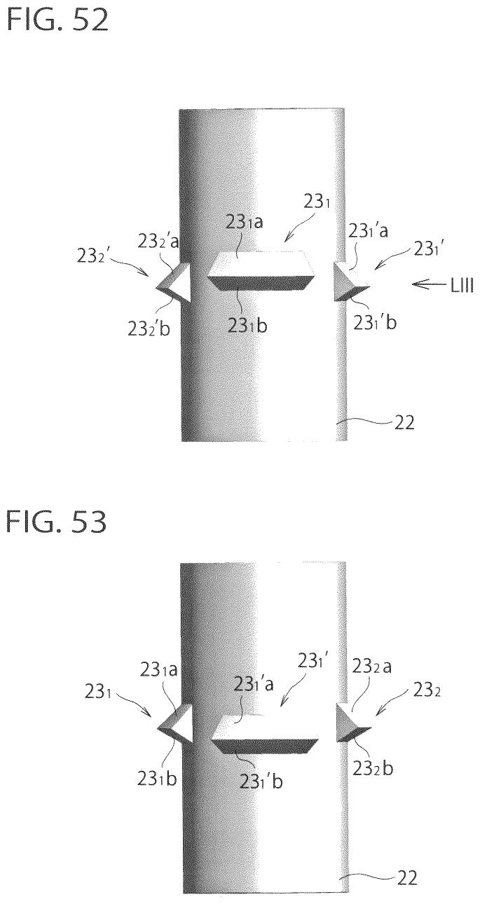

On the outer circumferential side of the backside surface 20a of the push button 20, a pair of protrusions 29₁, 29₂ are provided and the respective protrusions 29₁, 29₂ are oppositely disposed across the shaft portion 22. As shown in FIGS. 52 to 54, the outer circumference of the shaft portion 22 is provided with four ridge portions (protruding portions) 23₁, 23₂, 23₁′ and 23₂′ that protrude outwardly and extend a predetermined length along the circumferential direction. The respective ridge portions 23₁, 23₂, 23₁′ and 23₂′ are disposed 90 degrees or substantially 90 degrees apart from each other in the circumferential direction. The respective ridge portions 23₁, 23₂ are oppositely disposed across the shaft portion 22. Likewise, the respective ridge portions 23₁′, 23₂′ are oppositely disposed across the shaft portion 22.

As shown in FIGS. 52 and 53, the ridge portion 23₁ is formed of mutually intersecting upper-side inclined surface 23₁a and lower-side inclined surface 23₁b and has a longitudinal section of a triangular shape. The ridge portion 23₂ is formed of mutually intersecting upper-side inclined surface 23₂a and lower-side inclined surface 23₂b and has a longitudinal section of a triangular shape. Similarly, the ridge portion 23₁′ is formed of mutually intersecting upper-side inclined surface 23₁′a and lower-side inclined surface 23₁′b and has a longitudinal section of a triangular shape. The ridge portion 23₂′ is formed of mutually intersecting upper-side inclined surface 23₂′a and lower-side inclined surface 23₂′b and has a longitudinal section of a triangular shape. Also, the respective upper-side inclined surfaces 23₁′a, 23₂′a of the ridge portions 23₁′, 23₂′ are disposed slightly below the respective upper-side inclined surfaces 23₁a, 23₂a of the ridge portion 23₁, 23₂ in the axial direction. The respective lower-side inclined surfaces 23₁′b, 23₂′ b of the ridge portions 23₁′, 23₂′ are disposed slightly below the respective lower-side inclined surfaces 23₁b, 23₂b of the ridge portion 23₁, 23₂ in the axial direction.

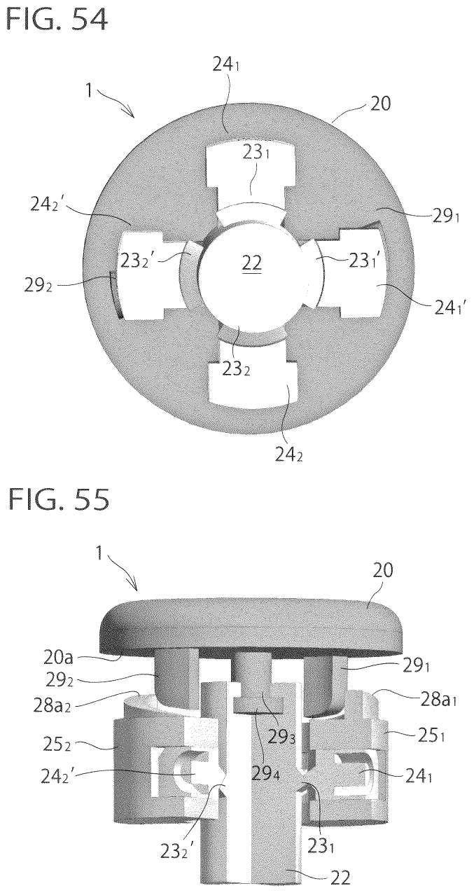

As shown in FIG. 54, engagement members 24₁, 24₂, 24₁′ and 24₂′ are disposed at respectively corresponding positions to the ridge portions 23₁, 23₂, 23₁′ and 23₂′ radially outside the shaft portion 22 (see FIG. 51). The respective engagement members 24₁, 24₂, 24₁′ and 24₂′ are circumferentially spaced 90 degrees (or substantially 90 degrees) apart from each other. The respective engagement members 24₁, 24₁′ are housed slidably in the guide portion 25₁. Likewise, the respective engagement members 24₂, 24₂′ are housed slidably in the guide portion 25₂. In addition, the respective guide portions 25₁, 25₂ are integrally formed with each other in the circumferential direction. Also, the inclined angles of the upper-side and lower-side inclined surfaces of the respective ridge portions 23₁, 23₂, 23₁′, 23₂′ and the inclined surfaces of the respective engagement members 24₁, 24₂, 24₁′, 24₂′ are preferably similar to those in the above-mentioned first embodiment

As shown in FIG. 50, on the guide portions 25₁, 25₂, a pair of circumferentially extending engagement portions 28a₁, 28a₂ are respectively provided. The respective engagement portions 28a₁, 28a; have an inclined surface whose height becomes gradually higher along the circumferential direction. In the state of FIG. 50 prior to the return operation, the bottom surfaces of the protrusions 29₁, 29₂ on the backside surface 20a of the push button 20 are respectively in contact with the top surfaces of the engagement members 28a₁, 28a₂. Also, at this juncture, the upper-side inclined surfaces 23₂a, 23₂a of the ridge portions 23₁, 23₂ of the shaft portion 22 are respectively in contact and engagement with the lower-side inclined surfaces of the engagement members 24₁, 24₂ (see FIG. 50), whereas between the upper-side inclined surfaces 23₁′ a, 23₂′a of the ridge portions 23₁′, 23₂′ of the shaft portion 22 and the lower-side inclined surfaces of the engagement members 24₁′, 24₂′, a clearance is formed (see FIGS. 50, 51).

Next, when pull-resetting the push button 20, the operator pulls up the push button 20 in the return operational direction (i.e. in the axially upward direction) from the state shown in FIG. 50. Then, the state is transferred from the state shown in FIG. 50 to the state shown in FIG. 55. At this juncture, as the push button 20 moves upwardly, the bottom surfaces of the respective protrusions 29₁, 29₂ of the backside surface 20a of the push button 20 move upwardly, slightly leaving the upper-side inclined surfaces of the engagement portions 28a₁, 28a₂. Accordingly, the shaft portion 22 moves upwardly along with the push button 20. As a result, the upper-side inclined surfaces 23₁a, 23₂a of the respective ridge portions 23₁, 23₂ of the shaft portion 22 move toward the distal-end side of the respective lower-side inclined surfaces of the engagement members 24₁, 24₂, contacting the lower-side inclined surfaces of the engagement members 24₁, 24₂, and the upper-side inclined surfaces 23₁′a, 23₂′a of the respective ridge portions 23₁′, 23₂′ of the shaft portion 22 come into contact with the lower-side inclined surfaces of the respective engagement members 24₁′, 24₂′ (see FIG. 55).

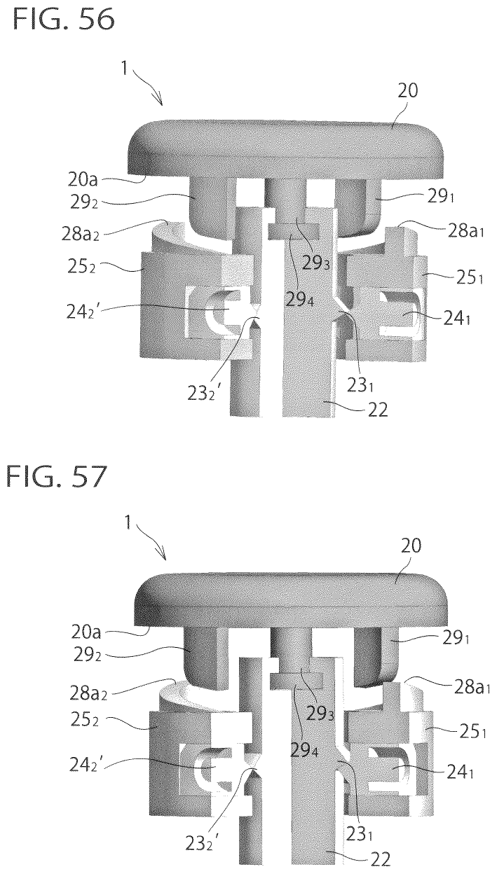

When the push button 20 moves further upwardly from the state shown in FIG. 55, the state is transferred to a state shown in FIG. 56. At this juncture, the bottom surfaces of the respective protrusions 29₁, 29₂ of the backside surface 20a of the push button 20 move upwardly further away from the top surfaces of the inclined surfaces of the engagement portions 28a₁, 28a₂. Accordingly, the shaft portion 22 moves further upwardly along with the push button 20. As a result, the upper-side inclined surfaces 23₁a, 23₂a of the respective ridge portions 23₁, 23₂ of the shaft portion 22 move to the position in the vicinity of the distal end of the lower-side inclined surfaces of the engagement members 24₁, 24₂, contacting with the lower-side inclined surface. At this time, the load of the respective engagement members 24₁, 24₂ on the push button 20 is the largest and thus the maximum return operational component force is applied in the return operational direction of the push button 20. Also, at this time, the upper-side inclined surfaces 23₁′ a, 23₂′ a of the respective ridge portions 23₁′, 23₂′ of the shaft portion 22 move toward the distal-end side of the lower-side inclined surfaces of the respective engagement members 24₁′, 24₂′, contacting with the lower-side inclined surfaces (see FIG. 56).

When the push button 20 moves further upwardly from the state shown in FIG. 56, the state is transferred to a state shown in FIG. 57. At this juncture, the bottom surfaces of the respective protrusions 29₁, 29₂ of the backside surface 20a of the push button 20 move further upwardly away from the inclined surfaces of the engagement portions 28a₁, 28a₂. Accordingly, the shaft portion 22 moves further upwardly along with the push button 20. As a result, the engagement state between the upper-side inclined surfaces 23₁a, 23₂a of the respective ridge portions 23₂, 23₂ of the shaft portion 22 and the lower-side inclined surfaces of the respective engagement members 24₁, 24₂ becomes disengaged, and then, the lower-side inclined surfaces 23₁b, 23₂b of the respective ridge portions 23₁, 23₂ come into engagement with the upper-side inclined surfaces of the engagement members 24₁, 24₂. On the other hand, at this juncture, the upper-side inclined surfaces 23₁′ a, 23₂′a of the respective ridge portions 23₁′, 23₂′ of the shaft portion 22 move to the position in the vicinity of the distal end of the lower-side inclined surfaces of the respective engagement members 24₁′, 24₂′, contacting with the lower-side inclined surfaces (see FIG. 57). At this time, the load of the respective engagement members 24₁′, 24₂′ on the push button 20 is the largest, and the maximum return operational component force is applied in the return operational direction of the push button 20.

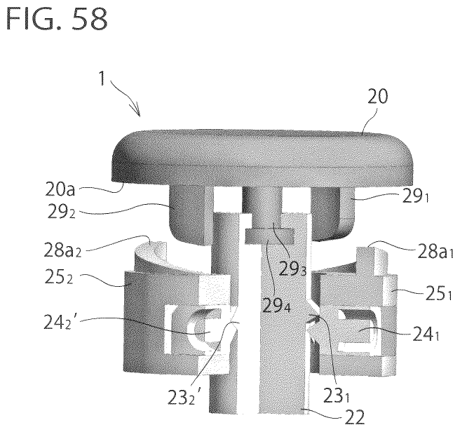

When the push button 20 moves further upwardly from the state shown in FIG. 57, the state is transferred to a state shown in FIG. 58. At this juncture, the bottom surfaces of the respective protrusions 29₁, 29₂ of the backside surface 20a of the push button 20 move further upwardly away from the inclined surfaces of the engagement portions 28a₁, 28a₂. Accordingly, the shaft portion 22 moves further upwardly along with the push button 20. As a result, the lower-side inclined surfaces 23₁b, 23₂b of the respective ridge portions 23₁, 23₂ of the shaft portion 22 move upwardly away from the upper-side inclined surfaces of the respective engagement members 24₁, 24₂. On the other hand, at this juncture, the engagement state between the upper-side inclined surfaces 23₁′ a, 23₂′a of the respective ridge portions 23₁′, 23₂′ of the shaft portion 22 and the lower-side inclined surfaces of the respective engagement members 24₁, 24₂ is disengaged. Immediately after this disengagement, due to the maximum return operational component force imparted to the push button 20, the push button 20 can move quickly with a large acceleration in the return operational direction. In such a manner, the respective pairs of contacts (see FIG. 5) can be surely prevented from causing a non-matching of contacts during the return operation. When the push button 20 moves to the state shown in FIG. 58, the return operation of the push button 20 is completed.

### Eighth Alternative Embodiment

In the above-mentioned first embodiment, an example was shown in which as a pair of contacts, in addition to two pairs of contacts of the first and second pairs of contacts C₁, C₂, two more pairs of contacts (that is, 4 pairs of contacts in total) are provided, but the present invention is also applicable to an example in which a different number of pairs of contacts from those in the first embodiment are provided (this is also true for the above-mentioned respective embodiments and alternative embodiments).

### Ninth Alternative Embodiment

In the above-mentioned first embodiment, an example was shown in which two engagement members 24₁, 24₂ are provided, but in the present invention, three or more engagement members may be provided (see the above-mentioned seventh alternative embodiment).

### Tenth Alternative Embodiment

In the above-mentioned first embodiment, an example was shown in which in order that the engagement surfaces 23₁a, 24₁a; 23₂a, 24₂a of the protrusions 23₁, 23₂ and the engagement members 24₁, 24₂, which mutually engage with each other during the return operation of the push button 20, are in surface contact with each other, the engagement surfaces 23₁a, 24₁a are formed of the inclined surfaces having identical or substantially identical inclined angle and the engagement surfaces 23₂a, 24₂a are formed of the inclined surfaces having identical or substantially identical inclined angle, but the application of the present invention is not restricted to such an example.

Either one of the engagement surfaces 23₁a, 24₁a may be formed of a convex circular-arc shaped surface that contacts the other of the engagement surfaces 23₁a, 24₁a. Likewise, either one of the engagement surfaces 23₂a, 24₂a may be formed of a convex circular-arc shaped surface that contacts the other of the engagement surfaces 23₂a, 24₂a. Also, the respective engagement surfaces may be formed of a planar surface and the inclined angle of the planar surface of either one of the engaged surfaces may differ from the inclined angle of the planar surface of the other of the engagement surfaces (see the above-mentioned sixth alternative embodiment).

### Eleventh Alternative Embodiment

In the above-mentioned first embodiment, an example was shown in which an opening biasing spring 27 (or 27₁, 27₂) is provided as an opening biasing means, but in the present invention, the opening biasing spring 27 (or 27₁, 27₂) may be omitted.

### Twelfth Alternative Embodiment

In the above-mentioned first alternative embodiment, an example was shown in which as shown in FIG. 22, the lower-side inclined surfaces (second inclined surfaces) 24₂a, 24₃a of the respective engagement members 24₂, 24₃ form an inclined angle β′ of 45 degrees relative to the axial line C, but the application of the present invention is not restricted to such an example.

As the inclined angle β′, an inclined angle similar to the angle S shown in the above-mentioned first embodiment may be employed. That is, as a value of β′,

$$50 ° < {β}^{′} < 70 °$$

More preferably,

β′=60°

Also, other than that the inclined angle β is applied to both of the engagement members 24₂, 24₃, the inclined angle β may be applied to either one of the respective engagement members 24₂, 24₃ and the inclined angle β′ may be applied to the other of the respective engagement members 24₂, 24₃.

### Thirteenth Alternative Embodiment

In the above-mentioned second alternative embodiment, an example was shown in which as shown in FIGS. 24 to 26, the inclined angle of the respective inclined surfaces of the protrusion (first engagement portion) 23₂ and the engagement member (second engagement portion) 24₂ is similar to that in FIG. 10 of the above-mentioned first embodiment, but the angle of these inclined surfaces may be similar to that in FIG. 13. In this case as well, due to a magnetically repulsive force (biasing force) applied between the contraposed respective magnet sheets (biasing means), the push button 20 can be biased on the pull-side, that is, in the return operational direction. Thereby, during the return operation of the push button 20, the return operation can be assisted to increase the return operational speed.

### Fourteenth Alternative Embodiment

In the above-mentioned second alternative embodiment, an example was shown in which the magnet sheets of the same magnetic polarity are oppositely disposed and a repulsive force is applied between the oppositely disposed respective magnetic sheets, but the application of the present invention is not restricted to such an example.

For example, as the magnet sheet 53 that is fitted to the housing case 30, a magnet sheet having different magnetic polarity from that of the magnet sheet 52 may be used and the magnet sheet 53 may be disposed at a predetermined interval above the magnet sheet 52 of FIG. 24. In this case, during the return operation of the push button 20, as the magnet sheet 52 moving along with the push button 20 approaches the magnet sheet 53, a magnetic attraction force is applied between the respective magnet sheets 52, 53. Thereby, the push button 20 can be biased to the pull-side, that is, in the return operational direction, thus assisting the return operation during the return operation of the push button 20.

### Other Alternative Example

The above-mentioned respective embodiments and alternative embodiments should be considered in all respects only as illustrative and not restrictive. Those skilled in the art to which the invention pertains may make various modifications and other embodiments employing the principles of the present invention without departing from its spirit or essential characteristics particularly upon considering the foregoing teachings, even if there are no explicit explanations in the description.

### EXAMPLES AND OTHER EXAMPLES OF APPLICATION

A preferred example of application for the push button switch of the present invention is an emergency stop switch, but the application of the present invention is not restricted to the emergency stop switch and is also applicable to other push button switch.

### INDUSTRIAL APPLICABILITY

The present invention is of use to a push button switch, and suitable especially to a push button switch for preventing an occurrence of non-matching of contacts.

### DESCRIPTION OF REFERENCE NUMERALS

1: push button switch
20: push button
21: holding case (case)
22A: shaft portion
22P: extension portion (partition member)
22s: seal member
22V₂: engagement groove
23₁, 23₂: protruding portion (first engagement portion)
23₁′, 23₂′: ridge portion (protruding portion/first engagement portion)
23₁a, 23₂a, 23₁b, 23₂b, 23₁′ a, 23₂′ a: inclined surface (engagement surface)
24₁, 24₂, 24₁′, 24₂′: engagement member (first engagement portion)
24₁a, 24₂a: second inclined surface (engagement surface/return-speed increasing means)
24₁b, 24₂b: first inclined surface (engagement surface)
26₁, 26₂: spring (biasing means)
27: opening biasing spring (opening biasing means)
28a: inclined surface (return-speed increasing means)
50, 51: magnet sheet (return-speed increasing means)
52, 53: magnet sheet (return-speed increasing means)
6: chamber
60, 60A, 60B: compartment
60d: concaved portion
C₁: first pair of contacts
C₂: second pair of contacts
F₁, F₂: load
F₁ sin β, F₂ sin β: return-operational component force
F₁ cos β, F₂ cos β: orthogonal component force

1. A push button switch comprising:
a push-operatable and return-operatable push button;
a first and second pairs of contacts that are respectively put in an open state by a push operation of said push button and put in a contact state by a return operation of said push button; and
a return-speed increasing means that applies and releases a load relative to said push button during said return operation of said push button and that functions to increase a return speed in a return-operational direction of said push button.

2. The push button switch according to claim 1,
wherein said return-speed increasing means includes a first engagement portion that is provided on the side of said push button and that moves along with said push button and a second engagement portion that is provided on the side of a case for holding said push button and that said first engagement portion is releasably engageable with,
wherein an engagement surface of at least either one of said first and second engagement portions is determined such that a load which acts from said first engagement portion to said second engagement portion becomes gradually greater during said return operation of said push button and when said load is resolved in said return-operational direction and an orthogonal direction relative to said return-operational direction, a return-operational component force in said return-operational direction is greater than an orthogonal component force orthogonal to said return-operational component force.

3. The push button switch according to claim 1, wherein said return-speed increasing means includes at least two first engagement portions that are provided on the side of said push button and that move along with said push button and at least two second engagement portions that are provided on the side of a case for holding said push button and that said first engagement portions are respectively releasably engageable with during said return operation of said push button.

4. The push button switch according to claim 1, wherein said return-speed increasing means includes a first engagement portion that is provided on the side of said push button and that moves along with said push button, a second engagement portion that is provided on the side of a case for holding said push button and that said first engagement portion is releasably engageable with, and a biasing means that biases said push button in said return-operational direction.

5. The push button switch according to claim 1, wherein said return-speed increasing means includes a first engagement portion that is provided on the side of said push button and that moves along with said push button, a second engagement portion that is provided on the side of a case for holding said push button and that said first engagement portion is releasably engageable with, a chamber that is provided on the side of said case, and a partition member that is adapted to move along with said push button, that partitions said chamber into two compartments, and that allows for air to move from one compartment in which an internal pressure is increased to another compartment during said return operation of said push button.

6. The push button switch according to claim 2,
wherein said first engagement portion is composed of a protruding part formed of a pair of inclined surfaces that are spaced away along an axial direction of a shaft portion of said push button,
wherein said second engagement portion is composed of an engagement member that includes a first inclined surface and a second inclined surface engageable with said respective inclined surfaces of said protruding part and that is provided movably toward and away from said protruding part of said push button, and
wherein a biasing means is provided that biases said engagement member toward said protruding part of said push button.

7. The push button switch according to claim 6, wherein one of said inclined surfaces of said protruding portion of said push button comes into engagement with said first inclined surface of said engagement member during said push operation, and the other of said inclined surfaces of said protruding potion of said push button comes into engagement with said second inclined surface of said engagement member during said return operation.

8. The push button switch according to claim 1, wherein said first pair of contacts are disposed on one side across said shaft portion of said push button, and said second pair of contacts are disposed on another side across said shaft portion of said push button.

9. The push button switch according to claim 1 further comprising an opening-biasing means that respectively biases said first and second pairs of contacts in opening directions.

10. The push button switch according to claim 9, wherein said opening-biasing means assists said push operation of an operator during said push operation of said push button and resists said return operation of said operator during said return operation of said push button.

11. The push button switch according to claim 1, wherein said push button switch is an emergency stop switch.
